(19) United States
(12) Patent Application Publication
(10) Pub. No.: US 2011/0099399 A1
(43) Pub. Date: Apr. 28, 2011

(54) INTEGRATED CIRCUIT DEVICE AND ELECTRONIC APPARATUS

(75) Inventors: Minoru TOMITA, Suwa-shi (JP); Katsuhiko MAKI, Chino-shi (JP); Masahiro ONODA, Suwa-gun (JP); Yasunari FURUYA, Suwa-gun (JP)

(73) Assignee: SEIKO EPSON CORPORATION, Tokyo (JP)

(21) Appl. No.: 12/908,220

(22) Filed: Oct. 20, 2010

(30) Foreign Application Priority Data
Oct. 26, 2009 (JP) 2009-245505

(51) Int. Cl. G06F 1/26

(52) U.S. Cl. 713/322

(57) ABSTRACT

An integrated circuit device includes: a host interface that receives a standard specification command and an internal specification command; a register unit; a logic circuit unit; and a first oscillation circuit, wherein the first oscillation circuit is controlled on the basis of a first command as the internal specification command and shifts to a state in which power supply voltage is supplied but oscillation is stopped, and the first oscillation circuit is controlled through the register unit on the basis of a second command as the internal specification command and returns to an oscillation state from the state in which the oscillation is stopped.

The entire disclosure of Japanese Patent Application No. 2009-245505, filed on Oct. 26, 2009 is expressly incorporated by reference herein.

### BACKGROUND

1. Technical Field

An aspect of the present invention relates to an integrated circuit device, an electronic apparatus.

2. Related Art

A reduction in power consumption is an important issue in a short-range radio communication terminal (a short-distance radio communication terminal) driven by a battery. A short-range radio communication technique can be applied to, for example, clocks and watches, toys, health equipment, game machines, and remote control apparatuses. Application to new fields such as medical and agricultural fields is also expected.

As a technique for reducing power consumption of a communication apparatus, for example, there are techniques respectively disclosed in JP-A-10-161766 (Patent Document 1), Japanese Patent No. 3621497 (Patent Document 2), JP-A-2007-200221 (Patent Document 3), JP-A-2003-323400 (e.g., FIG. 14 and descriptions of paragraphs 0152 to 0163) (Patent Document 4), and JP-T-2009-526438 (the term JP-T” as used herein means a published Japanese translation of a PCT application) (Patent Document 5). In the techniques disclosed in Patent Document 1 and Patent Document 2, supply of clocks to circuits is selectively stopped. In the technique disclosed in. Patent Document 3, power supply to an oscillation circuit as a generation source of an operation clock is stopped to stop the oscillation circuit.

In the technique disclosed in Patent Document 4, in a USB apparatus (an interface apparatus conforming to the universal serial bus standard), an oscillating operation of an oscillation circuit is stopped in a state in which power supply voltage for the oscillation circuit is on. In the technique disclosed in Patent Document 4, to start the oscillation circuit stopped oscillating, an external trigger signal called remote wakeup trigger or local wakeup trigger is used.

In the technique disclosed in Patent Document 5, each of plural apparatuses connected to a radio communication network independently provides a local communication hour and performs control for turning off a power supply for the apparatus by itself and turning on the power supply when the local communication hour set by the apparatus comes. According to Patent Document 5, an operation mode in which the apparatus keeps the power supply therefor off is called hibernation mode.

For example, as operation modes of a short-range radio communication apparatus, there are an active mode (a normal operation mode) and a low-power mode (a low-power consumption mode). According to standard specifications concerning the product (hereinafter referred to as standard specifications), for example, it is assumed that, normally, “even in the low-power mode, the short-range radio communication apparatus shifts to the active mode at a predetermined interval (e.g., every four minutes) and performs search for an idle channel”. As the “standard specifications”, for example, in-house standards concerning products, industry standards concerning products in a field of the industry, or product standards recommended by organizations related to products are conceivable. In this specification, the standard specifications are interpreted in a broadest sense.

However, depending on an environment in which the short-range radio communication terminal is used, the operation may be unnecessary. For example, when the short-range radio communication terminal is applied to the agricultural field and only has to transmit data of records of growing states of agricultural products and the like to an access point once in a day (twenty-four hours), it is evident that return to the active mode in every four minutes is meaningless. In this case, the short-range radio communication terminal only has to shift to the active mode only for a very short period once at determined timing in a day and transmit growth data of agricultural products accumulated in the past twenty-four hours to the access point. Power consumption occurs every time the short-range radio communication terminal shifts to a state of the active mode, for example, once in four minutes according to the standard specifications. Therefore, a further reduction in power consumption of the short-range radio communication terminal cannot be realized.

In other words, in the example explained above, contradiction (divergence) occurs between the standard specifications and an environment in which the short-range radio communication terminal is actually used (actual use conditions).

In the related arts (e.g., the techniques disclosed in Patent Document 1 to Patent Document 5), no consideration is made from the viewpoint of eliminating the contradiction (divergence) that occurs between the standard specifications and an environment in which an electronic apparatus is actually used (actual use conditions). Therefore, in the related arts, the contradiction cannot be eliminated.

### SUMMARY

An advantage of some aspects of the invention is to eliminate the contradiction (divergence) that occurs between the standard specifications and the environment in which the electronic apparatus is actually used (actual use conditions) and realize a further reduction in power consumption of the electronic apparatus and an integrated circuit device included in the electronic apparatus.

(1) An aspect of an integrated circuit device of the invention includes: a host interface that receives a standard specification command issued by a host and an internal specification command, which is a command asynchronous with the standard specification command; a register unit that is accessed through the host interface; a logic circuit unit including a command processing unit; and a first oscillation circuit that generates an operation clock for the logic circuit unit. The first oscillation circuit is controlled on the basis of a first command as the internal specification command issued by the host and shifts to a state in which power supply voltage is supplied but oscillation is stopped, whereby the logic circuit unit shifts to a state in which the power supply voltage is supplied but a circuit operation is stopped. The first oscillation circuit is controlled through the register unit on the basis of a second command as the internal specification command issued by the host and returns to an oscillation state from the state in which the oscillation is stopped, whereby the logic circuit unit returns to a state in which circuits operate from the state in which the circuit operation is stopped.

In this aspect, the operations of both the oscillation circuit and the logic circuit unit provided in the integrated circuit device are stopped according to the internal specification command (the first command) issued by the host (however, power supplies for the oscillation circuit and the logic circuit unit are on). A state in which the power supplies for the oscillation circuit and the logic circuit unit are on but the operations thereof are stopped can be regarded as a pseudo-hibernation state close to a state in which a power supply for the integrated circuit device is turned off (the expression “pseudo” has meaning that the integrated circuit device can more easily and quickly return to an operation state (wake up) compared with a hibernation state in which the power supply is completely off.

In the standard specifications, it is not specified at all to shift the integrated circuit device to the pseudo-hibernation state (when it is taken into account that turn-off of the power supply is option of a user, it can be said that there is no specific limitation in shifting the integrated circuit device to the state in which the power supply is off). Therefore, even if the integrated circuit device is shifted to the pseudo-hibernation state according to the internal specification command (the first command), this is not against the standard specification command. The standard specifications specify an operation procedure and the like taken when the integrated circuit device is in the operation state. Concerning an operation procedure and the like taken when the integrated circuit device is in a non-operation state (the power-off state or the pseudo-hibernation state), naturally, the standard specifications do not specify the operation procedure and the like (it can be said that, in this state, the standard specifications are not related to the operation of the integrated circuit device). Therefore, if the integrated circuit device is shifted to the pseudo-hibernation state according to the internal specification command (the first command), the integrated circuit device can be freed from the restriction (constraint) by the standard specifications.

Therefore, thereafter, the host only has to manage time using a timer, issue the internal command (the second command) when the operation of the integrated circuit device is necessary, and wake up the integrated circuit device. For example, application software created to be specialized for an environment in which the integrated circuit device is actually used can freely set timing for the wakeup. Therefore, according to this aspect, it is possible to realize, without being restricted by the standard specifications, an arbitrary sleep state (e.g., a long sleep state) adapted to an actual environment of use and realize ultra-low power consumption of the integrated circuit device. In other words, it is possible to shift the integrated circuit device to a state in which the integrated circuit device is tuned to minimum standby power.

Since the integrated circuit device is shifted to the pseudo-hibernation state or woken up from the pseudo-hibernation state by using the internal specification command, the host does not need to output a special control signal anew. A burden on the host can be minimized.

Both the standard specification command and the internal specification command are input through a common host interface (a standardized host interface) provided in the integrated circuit device. Therefore, it is unnecessary to provide a special I/O interface (i.e., special hardware) anew in order to shift the integrated circuit device to the pseudo-hibernation state and wake up the integrated circuit device from the pseudo-hibernation state.

In this aspect, when the integrated circuit device is returned from the pseudo-hibernation state to the operation state (the normal operation state), the register unit provided in the integrated circuit device is utilized. The register unit is often provided for, for example, debug (operation verification) for the integrated circuit device. If the register unit is also utilized for wakeup of the integrated circuit device, it is unnecessary to add special hardware. This makes it possible to return the integrated circuit device from the pseudo-hibernation state to the operation state (the normal operation state) (wake up the integrated circuit device) without adding a new circuit (without adding special hardware).

In this way, a pseudo-hibernation mode in this aspect is an unprecedented new operation mode in which, using the internal specification command and the register unit, it is possible to efficiently realize ultra-low power consumption of the integrated circuit device (IC) utilizing a command scheme and a circuit configuration of a standardized system. The “pseudo-hibernation mode” in this aspect can be paraphrased as “a sleep mode in which the internal specification command can be received”.

In other words, in the integrated circuit device according to this aspect, since all the operations of the oscillation circuit and the logic circuit unit are stopped (however, the power supplies are on and the power supplies for the host interface and the register unit are also on), it is possible to realize a further reduction in power consumption compared with the techniques of Patent Document 1 and Patent Document 2 for stopping only the clock supply to the circuits.

If the power supply for the oscillation circuit itself is turned off as in the technique of Patent Document 3, when oscillation is started, an operation for turning on the power supply for the oscillation circuit and an operation for inputting a power-on reset signal to the oscillation circuit are necessary and a burden on the host increases. If the power supply for the oscillation circuit is turned off, an operation for receiving the internal specification command and quickly waking up as in this aspect cannot be realized.

In the technique of Patent Document 4, the external trigger signal called remote wakeup trigger or local wakeup trigger is used in order to start the oscillation circuit in which oscillation is stopped. To use the external trigger, it is necessary to introduce a new control signal scheme different from a normal command scheme into the integrated circuit device and the burden on the host increases. In order to issue the remote wakeup trigger, the host needs to always detect transition of a state of the electronic apparatus. In order to issue the local wakeup trigger, the host needs to always monitor presence or absence of special interrupt. On the other hand, in this aspect, after issuing the first command (the internal specification command for instructing pseudo-hibernation), for example, the host only has to manage time using the timer and, when a predetermined time elapses, issue the second command (the internal specification command for instructing wakeup). Therefore, the burden on the host hardly occurs. In the technique of Patent Document 4, it is necessary to provide an I/O interface in the integrated circuit device anew. However, in this aspect, since the host interface that receives a normal command can be used in common, complication of a circuit configuration is prevented.

In Patent Document 5, the hibernation mode in which the electronic apparatus turns off the power supply for the electronic apparatus is adopted. However, in order to turn on the power supply for the integrated circuit device in the host, a power switch is necessary and an occupied area of the circuits increases. Therefore, it is difficult to adopt the hibernation mode in a portable apparatus and the like. Further, the integrated circuit device needs to wait for stabilization f the power supply and output of the power-on reset signal according to the turn-on of the power supply and cannot wake up quickly. On the other hand, in this aspect, a circuit operation for wakeup is quickly executed through the register unit. In other words, since the power supply is not off, it is possible to quickly return the first oscillation circuit to the oscillation state only with predetermined sequence control. In this way, the pseudo-hibernation mode in this aspect is an unprecedented new operation mode.

(2) In another aspect of the integrated circuit device of the invention, the integrated circuit device may further include: a second oscillation circuit used when the first oscillation circuit is started; and an oscillation starting circuit that operates according to an auxiliary clock output from the second oscillation circuit and executes sequence control for starting the first oscillation circuit. The second oscillation circuit may be controlled by the register unit on the basis of the second command as the internal specification command issued by the host and start the output of the auxiliary clock. The oscillation starting circuit may shift to an operation state according to the auxiliary clock output from the second oscillation circuit and execute the sequence control, whereby the first oscillation circuit may return to the oscillation state and, after the first oscillation circuit returns to the oscillation state, the second oscillation circuit may return to an oscillation stop state.

In this aspect, an example of a specific circuit configuration for waking up the integrated circuit device from the pseudo-hibernation state is clarified. In this aspect, the second oscillation circuit as an auxiliary oscillation circuit and the oscillation starting circuit (an oscillation wakeup circuit) that executes sequence control for starting the oscillation of the first oscillation circuit are provided. The operation of the second oscillation circuit is controlled through the register unit on the basis of the second command issued by the host. The auxiliary clock output from the second oscillation circuit is supplied to the oscillation starting circuit. The first oscillation circuit returns from the oscillation stop state to the oscillation state according to the sequence control by the oscillation starting circuit. The operation clock output from the first oscillation circuit is supplied to the logic circuit unit, whereby the logic circuit unit returns to the operation state.

Such a series of circuit operation for wakeup is quickly executed through the register unit (since the power supply is not off, it is possible to quickly return the first oscillation circuit to the oscillation state only with the predetermined sequence control). When the first oscillation circuit returns to the oscillation state, since the second oscillation circuit ends a role thereof, the second oscillation circuit returns to the oscillation stop state. Consequently, excess power consumption does not occur. As the second oscillation circuit, for example, an oscillation circuit that does not include an oscillator, is easily incorporated in the integrated circuit device, and has a relative simple configuration (e.g., an RC oscillation circuit) can be used.

(3) In still another aspect of the integrated circuit device of the invention, the host interface may be a serial interface of a clock synchronization type that transfers data in synchronization with a serial clock supplied from the host. The register unit may include a control register that can set a control bit for controlling the operation of the integrated circuit device. The register unit may start the operation on the basis of the serial clock obtained through the host interface. The control bit of the control register may be set on the basis of the second command. A control signal for returning the first oscillation circuit to the oscillation state may be output from the control register.

In this aspect, a more specific operation in waking up the integrated circuit device in the pseudo-hibernation state through the register unit on the basis of the second command issued by the host is clarified. In the pseudo-hibernation state, since the oscillation of the first oscillation circuit (and the second oscillation circuit) is stopped, the operation clock is not generated. In order to wake up the integrated circuit device, an operation clock for causing the circuits to operate is necessary. Therefore, in this aspect, the serial clock supplied from the host is used as the operation clock.

Specifically, when the host interface is the serial interface of the clock synchronization type (which may be simply referred to as synchronization type), the host outputs a serial clock for synchronization (which may be referred to as synchronization clock) simultaneously with issuance of a command (and output of data, etc.). The serial clock is received by the host interface together with the command. Specifically, for example, the serial clock supplied from the host can be used to cause a shift register provided in the host interface to operate. The serial clock can also be used as an operation clock for the register unit (e.g., provided near the host interface).

In view of this point, for example, the register unit is arranged near the host interface (e.g., may be arranged adjacent to the host interface). The serial clock input through the host interface is also supplied to the register unit to cause the register unit to operate. The serial clock can be directly used as the operation clock for the register unit. The operation clock can be generated on the basis of the serial clock. The second command input from the host is transferred from the host interface to the register unit. For example, a circuit operation is controlled on the basis of the second command through the control register included in the register unit.

For example, when a bit is set in a predetermined region of the control register (specifically, for example, a predetermined bit is set to an enable value), the control register outputs a control signal for returning the first oscillation circuit to the oscillation state. For example, when an example in which the second oscillation circuit is provided is assumed, the control register supplies a control signal for instructing the start of output of the auxiliary clock to the second oscillation circuit. At this point, if necessary, the serial clock can also be supplied as an operation clock for the second oscillation circuit. Accordingly, the second oscillation circuit (e.g., a built-in oscillator such as an RC oscillation circuit) is started and starts output of the auxiliary clock. The auxiliary clock is supplied to the oscillation starting circuit. This allows the oscillation starting circuit to shift to the operation state. The first oscillation circuit returns to the oscillation state according to the sequence control by the oscillation starting circuit (however, this is only an example and does not exclude shifting the first oscillation circuit to the oscillation state without using the oscillation starting circuit).

In this way, according to this aspect, it is possible to efficiently and rationally realize wakeup of the integrated circuit device from the pseudo-hibernation state with a simplest configuration without substantially using a special circuit configuration. The “pseudo-hibernation mode” in this aspect can be paraphrased as “a sleep mode in which the internal specification command can be received and a sleep mode in which it is possible to wake up the integrated circuit device using the serial clock (the synchronization clock) supplied from the host.

(4) In yet another aspect of the integrated circuit device of the invention, the control register may also be used when a debug mode as an operation mode for verifying the operation of the integrated circuit device is selected.

In this aspect, it is clarified that the register unit is also used in the debug mode. In other words, the register unit (which can be regarded as a part of a debug unit) used for debugging (verification of a circuit) is also used for switching of the operation mode of the integrated circuit device (i.e., shift to the pseudo-hibernation state and wakeup from the pseudo-hibernation state). Therefore, it is possible to realize switching of the operation mode of the integrated circuit device (i.e., shift to the pseudo-hibernation state and wakeup from the pseudo-hibernation state) without adding any new circuit.

(5) In still yet another aspect of the integrated circuit device of the invention, the second command may be issued when a predetermined time elapses after the host issues the first command. The elapse of the predetermined time may be measured by the host.

In this aspect, it is clarified that the second command (the internal specification command for waking up the integrated circuit device from the pseudo-hibernation state) is issued under time management by the host. As explained above, in the technique disclosed in Patent Document 4, in order to issue the remote wakeup trigger, the host needs to always detect transition of a state of the electronic apparatus. In order to issue the local wakeup trigger, the host needs to always monitor presence or absence of special interrupt. On the other hand, in this aspect, after issuing the first command (the internal specification command for instructing pseudo-hibernation), for example, the host only has to manage time with a timer and issue the second command (the internal specification command for instructing wakeup) when a predetermined time elapses. Therefore, a burden on the host hardly occurs.

Application software created to be specialized for an environment in which the integrated circuit device is actually used can freely set time from the issuance of the first command to the issuance of the second command. Therefore, according to this aspect, it is possible to realize, without limitations of the standard specifications, arbitrary long sleep adapted to an actual environment of use and realize ultra-low power consumption of the integrated circuit device. For example, ultra-long sleep in which the integrated circuit device wakes up only once in a month or once in several months is also possible (however, the long sleep is not limited to this example).

(6) In further another aspect of the integrated circuit device of the invention, the integrated circuit device may further include an analog circuit unit. The integrated circuit device may have a first operation mode in which both the analog circuit unit and a logic circuit unit are in the operation state and the first oscillation circuit is in the operation state, a second operation mode in which the analog circuit unit is in the non-operation state according to turn-off of the power supply voltage for the analog circuit unit, at least a part of the logic circuit unit is in the operation state, and the first oscillation circuit is in the operation state, and a third operation mode in which the analog circuit unit is in the non-operation state according to turn-off of the power supply voltage for the analog circuit unit and a circuit operation of the logic circuit unit is stopped according to the stop of the oscillation of the first oscillation circuit.

In this aspect, it is clarified that the integrated circuit device includes an analog circuit unit other than the logic circuit unit and there are the first to third operation modes as the operation modes of the integrated circuit device.

The first operation mode is an active mode. In the active mode, both the analog circuit unit and the logic circuit unit are in the operation state and the first oscillation circuit is also in the operation state. The second operation mode is a low-power mode (a low-power consumption mode). In the low-power mode, according to turn-off of the power supply voltage for the analog circuit unit, the analog circuit unit is in the non-operation state, at least a part of the logic circuit unit is in the operation state, and the first oscillation circuit is also in the operation state. The third operation mode is the pseudo-hibernation mode. In the pseudo-hibernation mode, according to turn-off of the power supply voltage for the analog circuit unit, the analog circuit unit is in the non-operation state and the first oscillation circuit is in the oscillation stop state. According to the stop of the oscillation of the first oscillation circuit, the circuit operation of the logic circuit unit is stopped. It is possible to switch the operation state of the integrated circuit device to be adapted to an actual environment of use by properly using the three operation modes.

(7) In still further another aspect of the integrated circuit device of the invention, the analog circuit unit may be a physical layer circuit for radio communication having at least one of a reception circuit that processes an input signal received by an antenna and a transmission circuit that executes processing for transmitting a signal from the antenna by radio. The logic circuit unit may include a data-link layer circuit that performs exchange of data between the physical layer circuit and the host and a physical-layer control circuit that controls the operation of the physical layer circuit.

In this aspect, the analog circuit unit is the physical layer circuit for radio communication. The logic circuit unit includes the data-link layer circuit that performs exchange of data between the physical layer circuit and the host and the physical layer control circuit that controls the operation of the physical layer circuit. Consequently, a new integrated circuit device for radio communication (IC for radio communication) is realized.

(8) In still yet further another aspect of the integrated circuit device of the invention, the logic circuit unit may include: a first timing control unit that controls operation timing for the physical layer circuit in the first operation mode; and a second timing control unit that controls operation timing for at least a part of the logic circuit unit in the second operation mode and controls shift from the first operation mode to the second operation mode and shift from the second operation mode to the first operation mode. An operation mode switching bit may be prepared in the register unit. At least one of the first timing control unit and the second timing control unit may switch, according to setting of the operation mode switching bit, a normal sequence operation mode for performing timing control for the integrated circuit device and a register control mode for controlling the operation of the integrated circuit device through the control register included in the register unit.

In this aspect, an example of a specific configuration for performing switching control for the first operation mode (the active mode) and the second operation mode (the low-power mode) and timing control for the circuits in the first operation mode (the active mode) is clarified. Switching control for the normal sequence operation mode and the register control mode are also clarified.

The operation modes of the integrated circuit device are roughly divided into the normal sequence operation mode (an operation mode including the first operation mode and the second operation mode in which, for example, sequence control is executed according to a protocol conforming to the standard specifications) and the register control mode for controlling, asynchronously with the normal sequence, the operations of the units of the integrated circuit device via the register unit on the basis of the internal specification command. The normal sequence operation mode and the register control mode are switched according to setting of the operation mode switching bit (e.g., setting a predetermined bit to an enable value). The operation mode switching bit is prepared in the register unit. The host can execute the setting of the operation mode switching bit.

The register control mode includes, for example, a debug mode (a test mode) and a pseudo-hibernation control mode for performing control for shift to the pseudo-hibernation state or wakeup from the pseudo-hibernation state.

When the normal sequence operation mode is selected, operation timings for the units are controlled by the first timing control unit and the second timing control unit provided in the logic circuit unit (the data-link layer circuit and the physical-layer control circuit). The first timing control unit controls operation timing for the physical layer circuit when the first operation mode (the active mode) is selected. The second timing control unit controls operation timing for at least a part of the logic circuit unit at the time when the second operation mode (the low-power mode) is selected (i.e., the circuit unit that is in the operation mode in the low-power mode). The second timing control unit also controls shift from the first operation mode (the active mode) to the second operation mode (the low-power mode) and shift from the second operation mode (the low-power mode) to the first operation mode (the active mode).

When the normal sequence operation mode is selected, sequence control (sequential timing control) by the first timing control unit and the second timing control unit based on the standard specification command is executed and transmission processing and reception processing for a radio communication single are performed. When the register control mode is selected, for example, the host issues the internal specification command and sets the operation mode switching bit in the register unit. Subsequently, the host issues the internal specification command for designating the operation mode. When the internal specification command issued at this point is the first command, the integrated circuit device shifts to the pseudo-hibernation mode. When the issued internal specification command is, for example, a command for instructing the debug mode, the integrated circuit device shifts to the debug mode.

In this way, according to this aspect, the command issued by the host is supplied to the integrated circuit device through hardware same as the command scheme of the standardized circuit system communication system (the standardized system). Although the command issued by the host is distinguished as the standard specification command or the internal specification command, a special command or a special control signal is not used at all. Control of the integrated circuit device from the outside is simplified. Therefore, the burden on the host is sufficiently suppressed. A reduction in the burden on the host also contributes to suppression of a circuit area of the host and a reduction in power consumption of the host.

(9) In a further aspect of the integrated circuit device of the invention, the reception circuit in the analog circuit unit may include: an amplifier circuit that amplifies an input signal based on a reception signal received by the antenna; a mixer that down-converts, with mixing of a local signal, a frequency of the signal amplified by the amplifier circuit; and a filter circuit that applies filtering processing to the signal after the down-convert. When the integrated circuit device is shifted from the second operation mode to the first operation mode, first, the second timing control unit may switch the power supply voltage for the reception circuit from off to on, then, shift the filter circuit to the operation state, shift the mixer to the operation state, and shift the amplifier circuit to the operation state.

In this aspect, an example of power supply management and operation procedure management in the reception circuit in the radio communication circuit at the time when the integrated circuit device shifts from the second operation mode (the low-power mode) to the first operation mode (the active mode) is clarified.

Since the first operation mode (the active mode) is an operation mode with largest power consumption, in the shift from the second operation mode (the low-power mode) to the first operation mode (the active mode), as a part of a reduction in power consumption, most rational power supply management and operation procedure management (with smallest power consumption) may be executed. Therefore, in this aspect, first, the power supply voltage for the reception circuit is switched from off to on (when power supply voltage for the amplifier circuit is separate from a power supply for the other reception circuits, the power supply voltage for the amplifier circuit is also raised at this point).

Subsequently, the filter circuit is shifted to the operation state. In other words, the circuit arranged at the post stage of the mixer is shifted to the operation state. Since the filter circuit is a circuit that processes the signal after the frequency is down-converted, power consumption of the filter circuit is considered to be small compared with that of a communication front-end unit (an RF circuit). Therefore, first, a circuit section at the post stage of the mixer including the filter circuit is shifted to the operation state.

Subsequently, the mixer is shifted to the operation state. When a complex mixer (an orthogonal mixer) is used, plural mixers are shifted to the operation state. Accordingly, for example, a local oscillator (the first oscillation circuit can be used as the local oscillator) that outputs a local signal and a PLL circuit may start operation. Since a mixer section (including a section related to the mixer) has large power consumption, return to the operation state of the mixer section is delayed. An increase in power consumption of the entire integrated circuit device is suppressed by delaying return to the operation state of the mixer section.

Subsequently, the amplifier circuit (e.g., a low-noise amplifier) is shifted to the operation state. Since the amplifier circuit (e.g., the low-noise amplifier) is a power amplifying circuit (a power amplifier) and has the largest power consumption, the amplifier circuit is returned to the operation state last. An increase in power consumption of the entire integrated circuit device is suppressed by returning the amplifier circuit to the operation state last.

In this way, in the shift from the second operation mode (the low-power mode) to the first operation mode (the active mode), as a part of a reduction in power consumption, most rational power supply management and operation procedure management (with smallest power consumption) are realized.

(10) In a still further aspect of the integrated circuit device of the invention, the second oscillation circuit may be used as a supply source of an operation clock to the circuits included in the integrated circuit device besides being used as a supply source of the auxiliary clock to the oscillation starting circuit.

In this aspect, the second oscillation circuit explained in (2) above is also used as a supply source of an operation clock to the other circuits. Consequently, effective use of the second oscillation circuit is realized. As the second oscillation circuit, for example, an oscillation circuit that does not include an oscillator, can be easily incorporated in the integrated circuit device, and has a relative simple configuration (e.g., an RC oscillation circuit) can be used (however, this is only an example and the second oscillation circuit is not limited to this).

(11) An aspect of an electronic apparatus of the invention includes: any one of the integrated circuit devices explained above; and a host as a host apparatus of the integrated circuit device.

As explained above, unprecedented long sleep can be performed by shifting the integrated circuit device to the pseudo-hibernation state. The configuration of the integrated circuit device is simplified and the burden on the host is reduced. These characteristics also contribute to miniaturization, ultra-low power consumption, and low cost of the electronic apparatus.

(12) In another aspect of the electronic apparatus, the electronic apparatus may be a radio communication apparatus driven by a battery.

According to this aspect, a small, light, ultra-low-power consumption, and low-cost radio communication device driven by a battery is realized. The radio communication device is, for example, a short-range radio communication terminal (a short-distance radio communication terminal) of the standard specifications (e.g., low-power consumption specifications).

In this way, according to at least one aspect of the invention, it is possible to eliminate contradiction (divergence) that occurs between the standard specifications and an environment in which the electronic apparatus is actually used (actual use conditions) and realize a further reduction in power consumption of the electronic apparatus and the integrated circuit device included in the electronic apparatus.

### BRIEF DESCRIPTION OF THE DRAWINGS

The invention will be described with reference to the accompanying drawings, wherein like numbers reference like elements.

FIG. 1 is a diagram showing an example of a form of use of a short-range radio communication terminal.

FIGS. 2A and 2B are diagrams for explaining a pseudo-hibernation mode (a third operation mode).

FIG. 3 is a diagram showing an example of a circuit configuration of a main part of a radio communication IC.

FIG. 4 is a diagram for explaining specific circuit configurations and operations of a host interface and a register unit.

FIG. 5 is a diagram showing an operation procedure for shifting the IC from a second operation mode (a low-power mode) to the third operation mode (the pseudo-hibernation mode).

FIG. 6 is a diagram showing an operation procedure for shifting the IC from the third operation mode (the pseudo-hibernation mode) to the second operation mode (the low-power mode).

FIG. 7 is a diagram showing an example of a specific internal configuration of the radio communication IC.

FIGS. 8A and 8B are diagrams showing examples of circuit configurations of a first oscillation circuit and a second oscillation circuit.

FIG. 9 is a diagram showing an operation procedure for turning on a power supply and shifting the IC to the low-power mode (the second operation mode).

FIG. 10 is a diagram for explaining an operation procedure for shifting the IC from the low-power mode (the second operation mode) to an active mode (a first operation mode).

FIG. 11 is a diagram showing an operation procedure for shifting the IC from the low-power mode (the second operation mode) to the pseudo-hibernation mode (the third operation mode).

FIG. 12 is a diagram showing an operation procedure for shifting the IC from the pseudo-hibernation mode (the third operation mode) to the low-power mode (the second operation mode).

FIG. 13 is a diagram showing another example of the specific internal configuration of the radio communication IC.

FIG. 14 is a timing chart showing an example of operation timings of power-on to the active mode of the radio communication IC shown in FIG. 13.

FIGS. 15A and 15B are diagrams showing examples of a power supply procedure in a reception circuit and a transmission circuit in the active mode and an operation procedure of the circuits.

FIG. 16 is a timing chart showing an example of operation timings of the active mode to the low-power mode and the pseudo-hibernation mode and operation timings of the pseudo-hibernation mode to the active mode through the low-power mode of the radio communication IC shown in FIG. 13.

### DESCRIPTION OF EXEMPLARY EMBODIMENTS

Exemplary embodiments of the invention are explained in detail below. The embodiments explained below do not unreasonably limit contents of the invention described in claims. All configurations explained in the embodiments are not always essential as means for resolution of the invention.

### First Embodiment

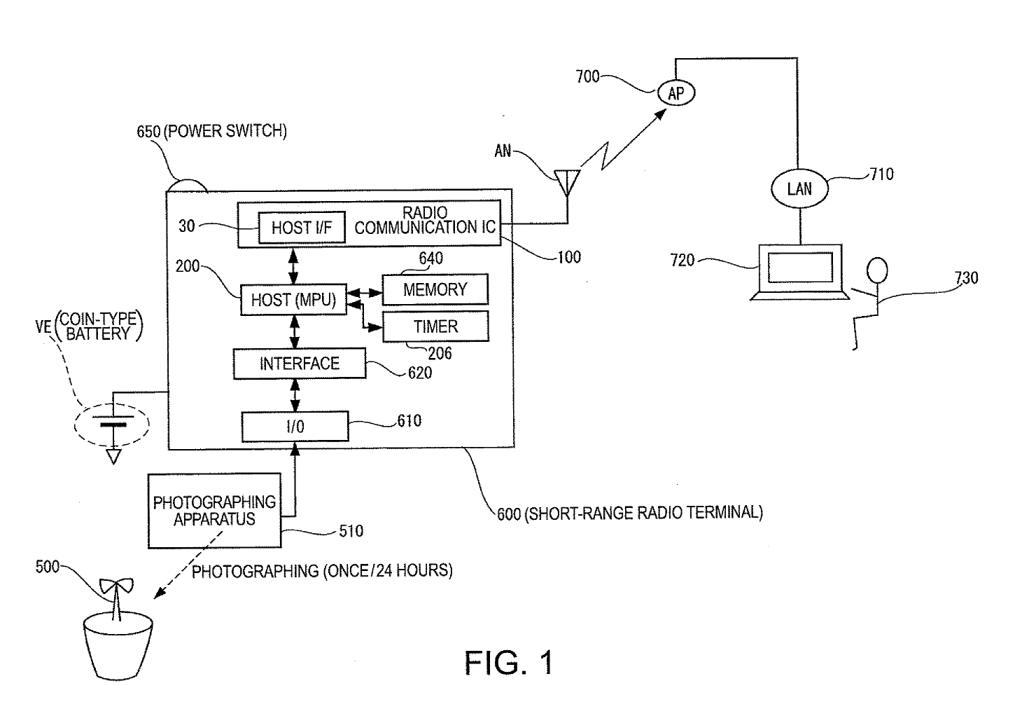

FIG. 1 is a diagram showing an example of a form of use of a short-range radio communication terminal. A radio communication system is adopted in a short-range radio communication terminal 600. The short-range radio communication terminal 600 includes an input and output unit (I/O) 610, an I/O interface 620, a host processor (e.g., MPU, hereinafter simply referred to as host) 200, a memory 640 (in which, for example, application software is stored), a timer 206, a radio communication IC (an integrated circuit device for radio communication) 100 (including a host interface (host I/F) 30), an antenna AN for radio communication, and a power switch 650. The short-range radio communication terminal 600 is a small, light, and ultra-low-power consumption radio portable terminal driven by, for example, a coin-type battery VE.

In the example shown in FIG. 1, the short-range radio communication terminal 600 is used for transmission of data indicating a growing state of a plant (or an agricultural product) 500 as an observation target to an access point 700. A photographing apparatus 510 instantaneously photographs (either still image photographing or moving image photographing) the growing state of the plant (or the agricultural product) 500 as the observation target, for example, once in twenty-four hours and transmits data of the photographing to the short-range radio communication terminal 600. The photographing data is transmitted from the antenna AN to the access point 700 by radio through the input and output unit (I/O) 610, the interface 620, the host 200, and the radio communication IC 100 of the short-range radio communication terminal 600. A distance from the antenna AN to the access point 700 is, for example, within several tens meters.

The access point 700 is connected to a monitoring display 720 through a LAN (local area network) 710. A user 730 (e.g., a researcher) can check a growing state of the plant (or the agricultural product) 500 as the observation target using the monitoring display 720.

Under such a state of use (an environment of use), the radio communication IC 100 mounted on the short-range radio communication terminal 600 only has to operate according to timing when the photographing data is input from the photographing apparatus 510. In other words, the radio communication IC 100 only has to operate for a short time once in twenty-four hours. In other periods, the radio communication IC 100 desirably shifts to a non-operation state to suppress consumption of the coin-type battery VE as a battery.

However, for example, when it is recommended by standard specifications that the radio communication IC returns to an operation state once in several minutes, contradiction between the standard specifications and the state of use (the environment of use) occurs. In other words, the example shown in FIG. 1, contradiction (divergence) could occur between provision contents of the standard specifications and an environment in which the short-range radio communication terminal 600 is actually used (actual use conditions).

To eliminate the contradiction, in this embodiment, a new operation mode for stopping the operation of an oscillation circuit, reducing power consumption of circuits to near zero, and quickly returning the oscillation circuit to an oscillation state using a serial clock from the host 200 is provided in the radio communication IC 100. In this specification, the operation mode provided anew is referred to as pseudo-hibernation mode (third operation mode). The expression “pseudo” has meaning that the radio communication IC can more easily and quickly return to the operation state (wake up) compared with a hibernation state in which a power supply is completely off.

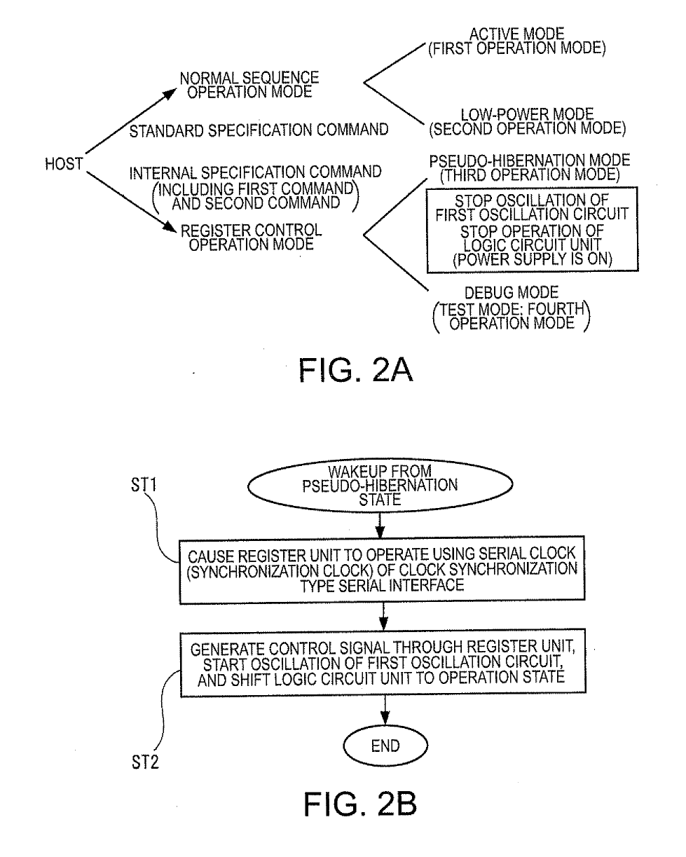

FIGS. 2A and 2B are diagrams for explaining the pseudo-hibernation mode (the third operation mode). FIG. 2A is a diagram showing an example of operation modes included in the IC (an integrated circuit device). As shown in FIG. 2A, the radio communication IC 100 includes, for example, a normal sequence operation mode (a normal operation mode) and a register control operation mode.

In the normal sequence operation mode (the normal operation mode), the host 200 issues a standard specification command conforming to the standard specifications. The normal sequence operation mode (the normal operation mode) includes, for example, an active mode (a first operation mode) and a low-power mode (a second operation mode). In the low-power mode (the second operation mode), a part of the circuits is controlled not to operate such that power consumption of the radio communication IC 100 is smaller than power consumption in the active mode (the first operation mode).

On the other hand, in the register control operation mode, the operation of the circuits (e.g., a circuit block) in the radio communication IC 100 is controlled on the basis of an internal specification command issued by the host 200 asynchronously with the standard specification command. Examples of the register control operation mode include a debug mode. Verification of a circuit operation, analysis of a broken section, and the like are important in realizing proper designing of an IC and production management. An on-chip debug tool is often provided in the IC. For example, a register unit (including a control register) is provided in the on-chip debug tool. For example, the operations of units of the IC can be separately controlled via the register unit.

In this embodiment, with attention paid to the register control operation mode, the pseudo-hibernation mode (the third operation mode) is provided anew under the register control operation mode. In the pseudo-hibernation mode (the third operation mode), oscillation of a first oscillation circuit (e.g., an oscillation circuit including a quartz oscillator) is stopped. Accordingly, the operation of a logic circuit unit stops (because an operation clock is not supplied). However, power supplies for the first oscillation circuit and the logic circuit unit are on.

The pseudo-hibernation mode (the third operation mode) can be realized by the internal specification command issued by the host 200. In other words, in the standard specifications, it is not specified at all that the radio communication IC 100 (hereinafter simply referred to as IC 100 in some case) is shifted to the pseudo-hibernation state. When it is taken into account that turning off the power supplies is option of a user, it can be said that there is no specific limitation in shifting the IC 100 to the state in which the power supplies are off. Therefore, even if the IC 100 is shifted to the pseudo-hibernation state according to the internal specification command (the first command), this is not against the standard specification command. The standard specifications specify an operation procedure and the like taken when the IC 100 is in the operation state. Concerning an operation procedure and the like taken when the IC 100 is in a non-operation state (the power-off state or the pseudo-hibernation state), naturally, the standard specifications do not specify the operation procedure and the like (it can be said that, in this state, the standard specifications are not related to the operation of the IC 100). Therefore, if the IC 100 is shifted to the pseudo-hibernation state according to the internal specification command (the first command), the IC 100 can be freed from the restriction (constraint) by the standard specifications.

Therefore, thereafter, the host 200 only has to manage time using the timer 206, issue an internal command (a second command) when the operation of the IC 100 is necessary, and wake up the IC 100. For example, application software created to be specialized for an environment in which the IC 100 is actually used can freely set timing for the wakeup. Therefore, it is possible to realize, without being restricted by provisions of the standard specifications, an arbitrary sleep state (e.g., a long sleep state) adapted to an actual environment of use and realize ultra-low power consumption of the IC 100. In other words, it is possible to shift the IC 100 to a state in which the IC 100 is tuned to minimum standby power.

Since the IC 100 is shifted to the pseudo-hibernation state or woken up from the pseudo-hibernation state by using the internal specification command, the host 200 does not need to output a special control signal anew. A burden on the host 200 can be minimized.

Both the standard specification command and the internal specification command are input through a common host interface (a standardized host interface) provided in IC 100. Therefore, it is unnecessary to provide a special I/O interface (i.e., special hardware) anew in order to shift the IC 100 to the pseudo-hibernation state and wake up the IC 100 from the pseudo-hibernation state. In other words, since the host interface that receives a normal command can be used in common, complication of a circuit configuration is prevented. Since it is unnecessary to introduce a new control signal scheme different from a normal command scheme into the IC 100, the burden on the host 200 does not increase.

After issuing the first command (the internal specification command for instructing pseudo- hibernation), for example, the host 200 only has to manage time using the timer 206 and, when a predetermined time elapses, issue the second command (the internal specification command for instructing wakeup from the pseudo-hibernation state). Therefore, the burden on the host 200 hardly occurs. For example, application software created to be specialized for an environment in which the IC 100 is actually used can freely set time from issuance of the first command until issuance of the second command. Therefore, it is possible to realize, without limitations of the standard specifications, arbitrary long sleep adapted to an actual environment of use and realize ultra-low power consumption of the IC 100. For example, ultra-long sleep in which the CI 100 wakes up only once a month or once in several months is also possible (the long sleep is not limited to this example).

FIG. 2B is a diagram of an example of a procedure for waking up the IC (the integrated circuit device) in the pseudo-hibernation state. In the pseudo-hibernation state, since the oscillation of the first oscillation circuit (e.g., the oscillation circuit including the quartz oscillator) is stopped, the operation clock is not generated. In order to wake up the IC 100, an operation clock for causing the circuits to operate is necessary. Therefore, in this embodiment, the serial clock supplied from the host 200 is used as the operation clock.

Specifically, when the host interface (host I/F) 30 is a serial interface of a clock synchronization type (which may be simply referred to as synchronization type), the host 200 outputs a serial clock for synchronization (which may be referred to as synchronization clock) simultaneously with issuance of a command (and output of data, etc.). The serial clock is received by the host interface (host I/F) 30 together with the command. Specifically, for example, the serial clock supplied from the host 200 can be used to cause a shift register provided in the host interface (host I/F) 30 to operate. The serial clock can also be used as an operation clock for the register unit. For example, the register unit may be arranged near the host interface 30. Specifically, the register unit may be arranged adjacent to the host interface 30. In this case, clock supply and data transfer to the register unit are easy.

In view of such a point, in step ST1 in FIG. 2B, for example, the register unit is arranged near the host interface 30 and a serial clock input through the host interface 30 is also supplied to the register unit to cause the register unit to operate (the serial clock can be directly used as the operation clock for the register unit or the operation clock can be generated on the basis of the serial clock).

In step ST2 in FIG. 2B, for example, the second command (the internal specification command) input from the host 200 is transferred from the host interface 30 to the register unit. For example, a circuit operation is controlled through a control register included in the register unit on the basis of the second command. In other words, a control signal is generated through the register unit, the first oscillation circuit is started to oscillate, and the logic circuit unit is shifted to the operation state.

By adopting the new operation mode (the third operation mode) explained with reference to FIGS. 2A and 2B in this way, it is possible to efficiently and rationally realize wakeup from the pseudo-hibernation state of the integrated circuit device with a simplest configuration without substantially using a specific circuit configuration. The third operation mode (the pseudo-hibernation mode) is an operation mode provided anew on the basis of a new object of eliminating contradiction between the standard specifications and an actual condition of use. The third operation mode is an unprecedented new operation mode for, using the internal specification command and the register unit, making it possible to efficiently realize ultra-low power consumption of the integrated circuit device (IC) utilizing a command scheme and a circuit configuration of a standardized system. The “pseudo-hibernation mode” can be paraphrased as “a sleep mode in which the internal specification command can be received” or “a sleep mode in which the internal specification command can be received and a sleep mode in which it is possible to wake up the integrated circuit device using a serial clock (a synchronization clock)”.

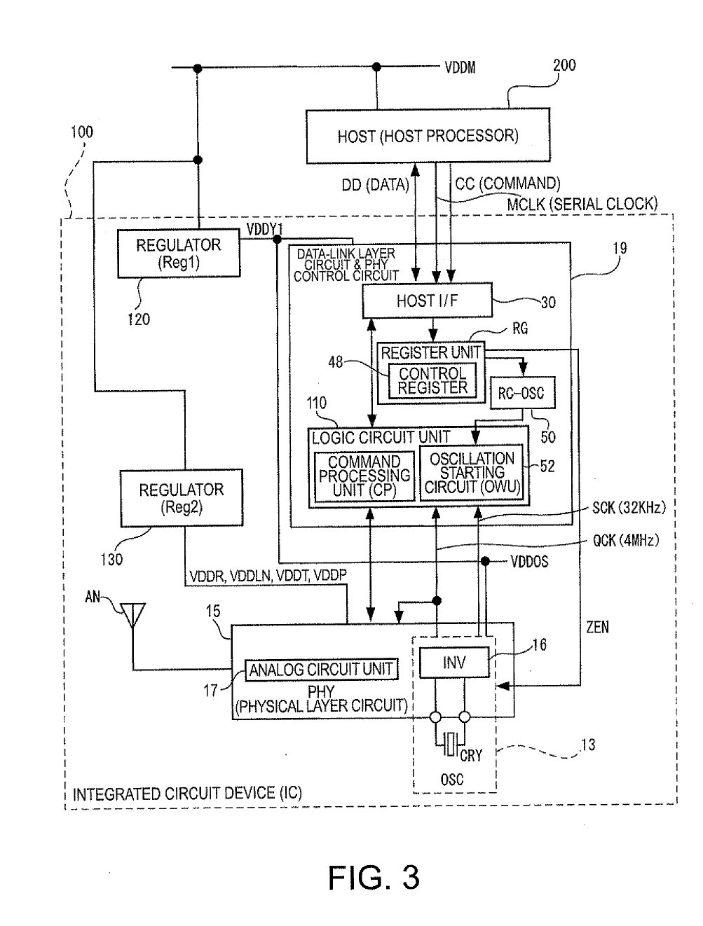

FIG. 3 is a diagram showing an example of a circuit configuration of a main part of the radio communication IC. The radio communication IC 100 includes a physical layer circuit (PHY) 15 (including an analog circuit unit 17), a first oscillation circuit (OSC) 13 (including a quartz oscillator CRY and an inverter (INV) 16), a data-link layer circuit and physical layer control circuit (PHY control circuit) 19, a first regulator (Reg1) 120 and a second regulator (Reg2) 130. The data-link layer circuit executes exchange of data between the physical layer circuit 15 and the host 200. The physical layer control circuit (hereinafter referred to as PHY control circuit) controls the operation of (at least a part of) the physical layer circuit 15.

The data-link layer circuit and PHY control circuit 19 includes the host interface (host I/F) 30, a register unit RG (including a control register 48), an RC oscillation circuit (RC-OSC) 50, as the second oscillation circuit, incorporated in the IC 100, and a logic circuit unit 110.

The logic circuit unit 110 operates according to an operation clock (in the following explanation, may be referred to as normal clock) output from the first oscillation circuit (OSC) 13. The logic circuit unit 110 includes a command processing unit CP and an oscillation starting circuit (an oscillator wakeup unit (OWU) 52 that executes sequence control for starting the first oscillation circuit (OSC) 13 to oscillate.

The command processing unit CP is a circuit block having a function of interpreting a command received via the host interface (host I/F) 30 and executing the command. The command processing unit CP can be provided in, for example, a protocol processing unit (not shown in FIG. 3) that executes sequence control based on a protocol conforming to the standard specifications.

The oscillation starting circuit (OWU) 52 operates according to an operation clock (hereinafter referred to as auxiliary clock) output by the RC oscillation circuit (RC-OSC) 50 as the second oscillation circuit. Predetermined sequence control is necessary for starting oscillation of the first oscillation circuit (OSC) 13. In order to execute the sequence control, time measurement for determining output timing for a control signal is necessary. The auxiliary clock output by the RC oscillation circuit (RC-OSC) 50 as the second oscillation circuit can be used for the time measurement.

The first regulator (Reg1) 120 and the second regulator (Reg2) 130 are provided as power supply system circuits. The first regulator (Reg1) 120 generates, on the basis of an external power supply VDDM, power supply voltage VDDY1 (e.g., 1.8V) for the data-link layer circuit and PHY control circuit 19 and power supply voltage VDDOS for the first oscillation circuit (OSC) 13 and outputs the power supply voltage VDDY1 and the power supply voltage VDDOS. Since the first regulator (Reg1) 120 is provided, it is possible to always supply highly-accurate power supply voltage to the data-link layer circuit and PHY control circuit 19 and the first oscillation circuit (OSC) 13.

The second regulator (Reg2) 130 generates, on the basis of the external power supply VDDM, power supply voltages for the physical layer circuit (PHY) 15 (e.g., power supply voltage VDDR for a reception circuit and power supply voltage VDDLN for a low-noise amplifier. The host 200 also operates with the external power supply VDDM.

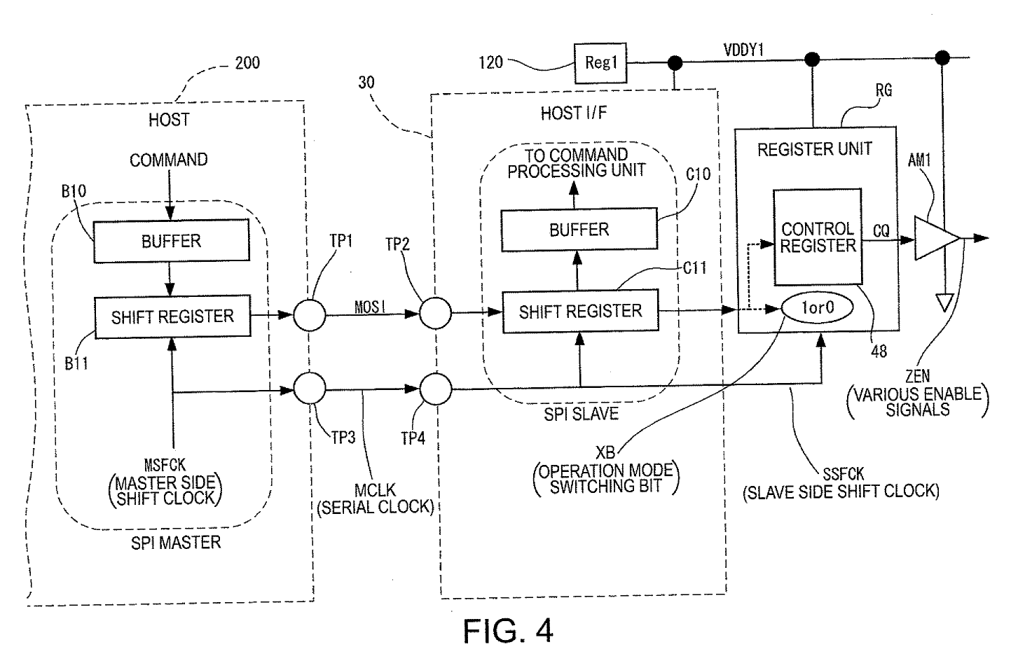

FIG. 4 is a diagram for explaining specific circuit configurations and operations of the host interface and the register unit shown in FIG. 3. In FIG. 4, serial communication of a synchronization type is used for communication between the host 200 and the host interface (host I/F) 30 in the radio communication IC 100. It is assumed that an SPI (serial peripheral interface) is used (however, this is only an example and the serial communication is not limited to this). The host 200 includes an SPI master. The host interface (host I/F) 30 includes an SPI slave.

The SPI master includes a buffer 810 and a shift register B11. Similarly, the SPI slave includes a buffer C10 and a shift register C11. The shift register B11 operates according to a master side shift clock MSFCK. The master side shift clock MSFCK is transmitted to the SPI slave through terminals TP3 and TP4 as a serial clock (a synchronization clock) MCLK. Data such as a command issued by the host 200 is transmitted to the SPI slave through the terminals TP3 and TP4. The shift register C11 in the SPI slave operates using the serial clock (the synchronization clock) MCLK, which is input through the terminal TP4, as an operation clock. The shift register C11 receives and stores the data such as the command input through the terminal TP2 and transfers the received data in synchronization with the operation clock.

In the example shown in FIG. 4, the register unit RG is arranged near the host interface (host I/F) 30 (for example, the register unit RG is arranged adjacent to the host I/F 30). Since the host I/F 30 and the register unit RG are close to each other in this arrangement, it is easy to supply the serial clock MCLK, which is input through the host interface (host I/F) 30, to the register unit RG and cause the register unit RG to operate. The serial clock MCLK can be directly used as the operation clock for the register unit RG. The operation clock can be generated on the basis of the serial clock MCLK.

For example, the second command (the command instructing wakeup from the pseudo-hibernation mode) as the internal specification command input from the host 200 is transferred from the host interface (host I/F) 30 to the register unit RG. For example, a control bit is set in the control register 48 included in the register unit RG on the basis of the second command. A control signal CQ is output from the control register 48. For example, the control signal CQ is amplified by an amplifier AM1 and output as various enable signals ZEN. The output various enable signals ZEN are supplied to a control target circuit,

Specifically, for example, when a bit is set in a predetermined region of the control register 48 (specifically, for example, a predetermined bit is set as an enable value), the control register 48 supplies the control signal CQ for returning the first oscillation circuit (OSC) 13 to the oscillation state (the control signal CQ for instructing the start of output of the auxiliary clock) to the RC oscillation circuit (RC-OSC) 50 as the second oscillation circuit. At this point, if necessary, the serial clock MCLK can also be supplied as an operation clock for the RC oscillation circuit (RC-OSC) 50 as the second oscillation circuit. Accordingly, the RC oscillation circuit (RC-OSC) 50 as the second oscillation circuit is started and starts the output of the auxiliary clock. The auxiliary clock is supplied to the oscillation starting circuit (OWU) 52. The oscillation starting circuit (OWU) 52 shifts to the operation state according to the auxiliary clock. The first oscillation circuit (OSC) 13 can be returned to the oscillation state according to the sequence control by the oscillation starting circuit (OWU) 52. (However, this is only an example and does not exclude shifting the first oscillation circuit (OSC) 13 to the oscillation state without using the oscillation starting circuit (OWU) 52).

In this way, according to the examples shown in FIGS. 3 and 4, it is possible to efficiently and rationally wake up the IC 100 from the pseudo-hibernation state with a simplest configuration without substantially using a special circuit configuration. Similarly, it is also possible to output a control signal through the control register 48 according to the internal specification command, shift the first oscillation circuit (OSC) 13 to the oscillation stop state, and easily shift the IC 100 to the pseudo-hibernation state.

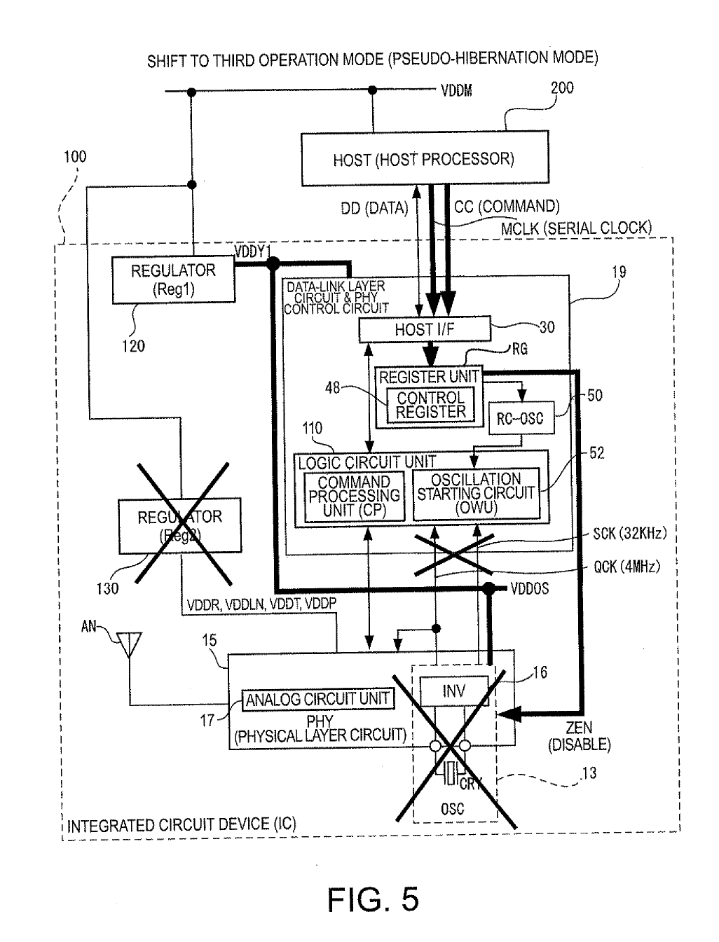

FIG. 5 is a diagram showing an operation procedure for shifting the IC from the second operation mode (the low-power mode) to the third operation mode (the pseudo-hibernation mode). In FIG. 5, to facilitate understanding, sections and various signals related to the shift to the third operation mode (the pseudo-hibernation mode) are indicated by thick solid lines. In FIG. 5, × marks affixed to circuits indicate that the circuits are in the non-operation state or shift to the non-operation state according to control performed through the register unit or the like. A × mark affixed to a signal such as a clock indicates that output of the signal such as the clock is stopped (the same applied to the other drawings).

In the second operation mode (the low-power mode), the second regulator (Reg2) 130 is in the non-operation mode. The power supply voltages (VDDR, VDDLN, etc.) are not supplied to the physical layer circuit (PHY) 15. Therefore, the physical layer circuit (PHY) 15 is in the non-operation state. However, the first regulator (Reg1) 120 is operating. The first regulator (Reg1) 120 outputs the power supply voltage VDDY1 for the data-link layer circuit and PHY control circuit 19 and the power supply voltage VDDOS for the first oscillation circuit (OSC) 13.

In the first operation mode (the active mode), the first oscillation circuit (OSC) 13 outputs both a quick clock QCK (e.g., 4 MHz) and a slow clock SCK (e.g., 32 KHz). In the second operation mode (the low-power mode), the first oscillation circuit (OSC) 13 outputs only the slow clock SCK (e.g., 32 KHz). The slow clock SCK (e.g., 32 KHz) is used as, for example, an operation clock for a circuit section operating in the second operation mode (the low-power mode) in the data-link layer circuit and PHY control circuit 19.

In this state, when a command CC (the first command as the internal specification command) is output from the host 200 together with the serial clock MCLK, the command CC and the serial clock MCLK are received by the host interface (host I/F) 30. The register unit RG (the control register 48) operates and the control signals ZEN shift to a disable state. Accordingly, the first oscillation circuit (OSC) 13 shifts to the oscillation stop state and the output of the slow clock SCK stops. Accordingly, the logic circuit unit 110 shifts to the non-operation state. In this way, the IC 100 shifts from the second operation mode (the low-power mode) to the third operation mode (the pseudo-hibernation mode).

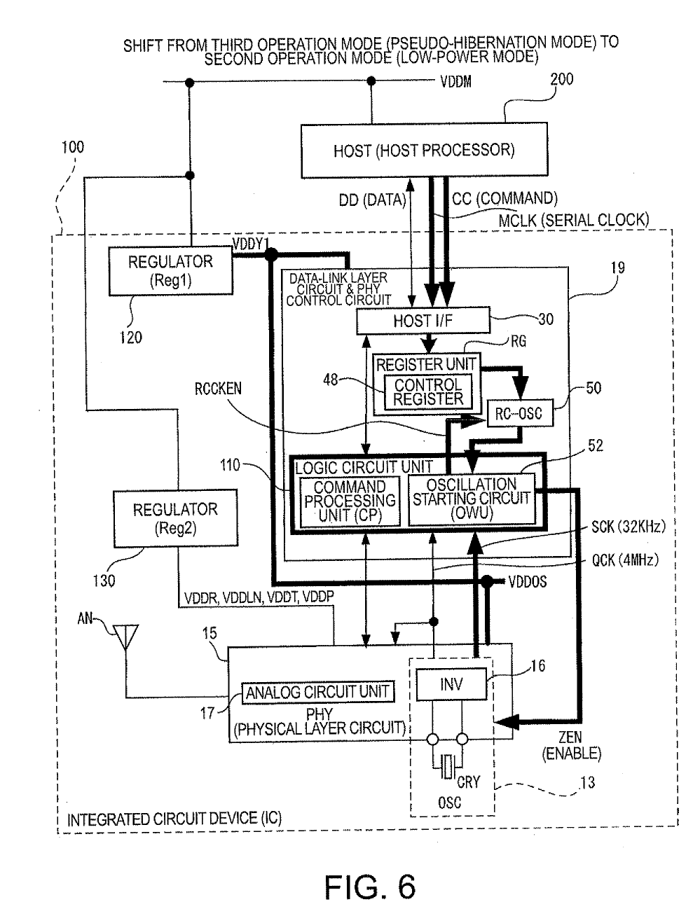

FIG. 6 is a diagram showing an operation procedure for shifting the IC from the third operation mode (the pseudo-hibernation mode) to the second operation mode (the low-power mode).

When a command CC (the second command as the internal specification command) is output from the host 200 together with the serial clock MCLK, the command CC and the serial clock MCLK are received by the host interface (host I/F) 30. The register unit RG (the control register 48) operates and the RC oscillation circuit (RC-DSC) 50 as the second oscillation circuit is started. The auxiliary clock output from the RC oscillation circuit (RC-OSC) 50 is supplied to the oscillation starting circuit (OWU) 52. The control signals ZEN shift to the enable state according to the sequence control by the oscillation starting circuit (OWU) 52. Accordingly, the first oscillation circuit (OSC) 13 returns to the oscillation state. The slow clock SCK output from the first oscillation circuit (OSC) 13 is supplied to the logic circuit unit 110. Accordingly, the logic circuit unit 110 returns to the operation state. In this way, the IC 100 can quickly wake up from the third operation mode (the pseudo-hibernation state).

### Second Embodiment

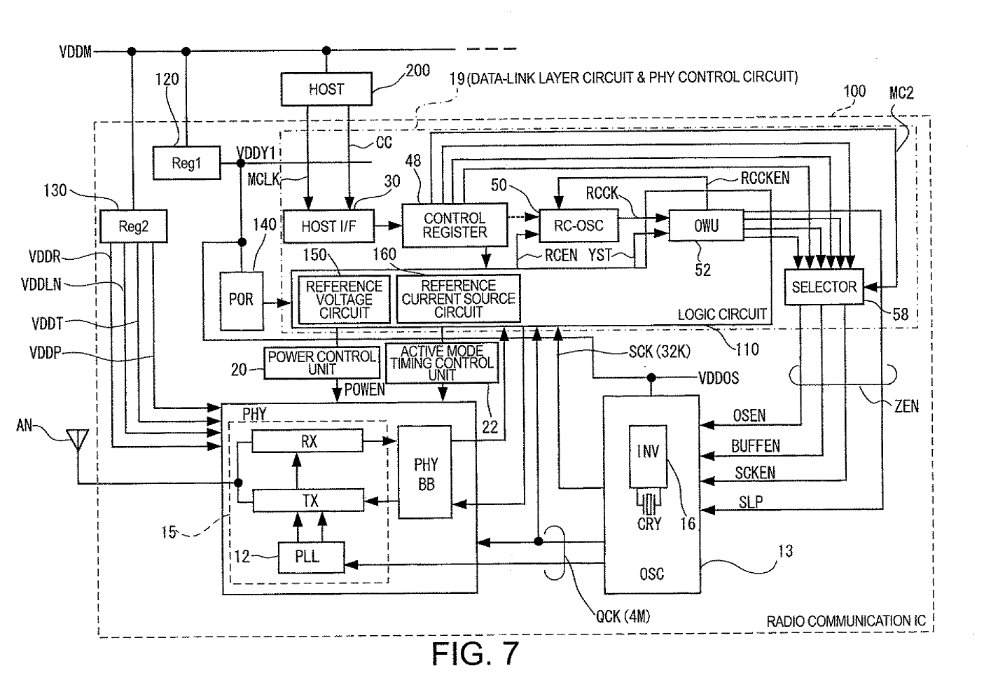

In a second embodiment, examples of an internal configuration and operations of the radio communication IC 100 are specifically explained with reference to FIGS. 7 to 12. FIG. 7 is a diagram showing an example of a specific internal configuration of the radio communication IC. In FIG. 7, components same as those shown in the figures referred to above are denoted by the same reference numerals and signs. Redundant explanation of the components explained above is omitted. Only components added anew are explained.

As shown in a lower side of FIG. 7, the physical layer circuit (PHY) 15 includes the analog circuit unit 17 and a physical layer baseband control unit PHYBB. The analog circuit unit 17 includes a reception circuit RX, a transmission circuit TX, and a PLL circuit 12. In order to control the operation of the physical layer circuit (PHY) 15, a power control unit 20 and an active-mode-timing control unit 22 are provided. In order to prevent malfunction of a flip-flop during power-on, a power-on reset circuit (POR) 140 is provided. The logic circuit unit 110 (including the data-link layer circuit and PHY control circuit 19) includes a reference voltage circuit 150 and a reference current source circuit 160. These circuits also operate in the third operation mode (the pseudo-hibernation mode). Therefore, several logic gates, element circuits, and the like can also operate in the third operation mode (the pseudo-hibernation mode). Consumed current in the third operation mode (the pseudo-hibernation mode) is, for example, about 400 μA. The IC 100 is tuned to minimum standby power.

In the example shown in FIG. 7, the control register 48 can supply control signals (the control signals ZEN: specifically, an oscillation enable signal OSEN, a buffer enable signal BUFFEN, a slow clock enable signal SCKEN, and a sleep control signal SLP). The oscillation starting circuit (OWU) 52 can also supply the signals. A selector 58 is provided to switch a signal route with the control register 48 set as a transmission source and a signal route with the oscillation starting circuit (OWU) 52 set as a transmission source. The route switching by the selector 58 is controlled according to, for example, a switching control signal MC2 output from the control register 48.

In the example shown in FIG. 7, the second regulator (Reg2) 130 outputs power supply voltage VDDR for the reception circuit RX, power supply voltage VDDLN for the low noise amplifier included in the reception circuit RX, power supply voltage VDDT for the transmission circuit TX, and power supply voltage VDDP for a power amplifier included in the transmission circuit TX.

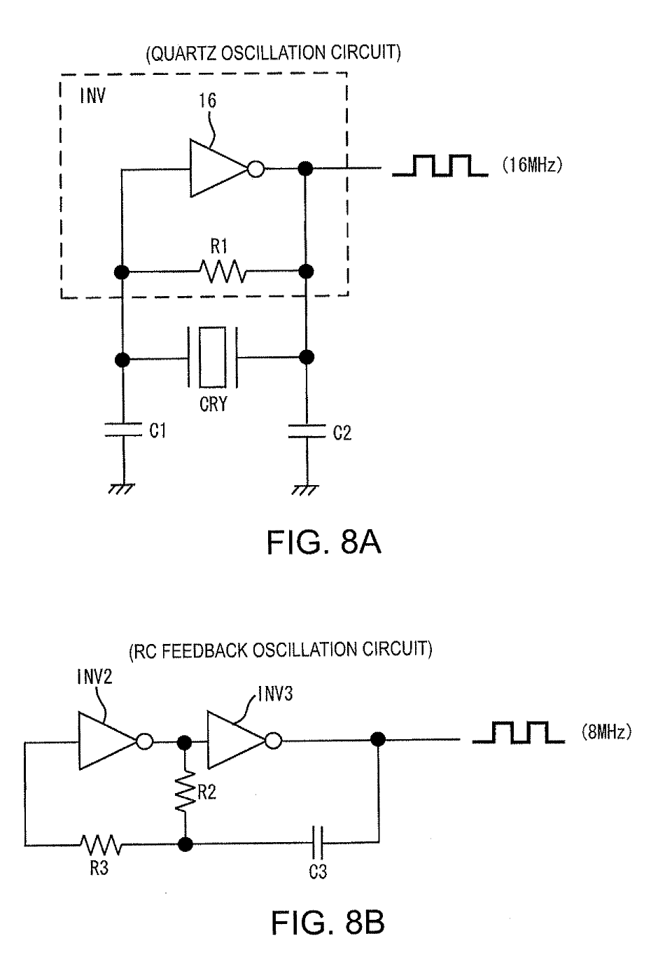

FIGS. 8A and 8B are diagrams showing examples of circuit configurations of the first oscillation circuit and the second oscillation circuit. FIG. 8A is a diagram showing an example of a circuit configuration of the first oscillation circuit (OSC) 13. The first oscillation circuit (OSC) 13 can include capacitors C1 and C2, a quartz oscillator CRY, a resistor R1, and an inverter (INV) 16. A frequency of source oscillation of the first oscillation circuit (OSC) 13 is, for example, 16 MHz. A quick clock QCK (4 M) and a slow clock SCLK (32 K) can be generated by frequency-dividing a clock of the source oscillation.

FIG. 8B is a diagram showing an example of a circuit configuration of the second oscillation circuit (RC-OSC) 50. The second oscillation circuit (RC-OSC) 50 includes a capacitor C3, resistors R2 and R3, and inverters INV2 and INV3. An oscillation frequency of the second oscillation circuit (RC-OSC) 50 is set to a high frequency such as 8 HMz. The oscillation frequency is set taking into account that the second oscillation circuit (RC-CSC) 50 is also used as an operation clock supply source for other circuits (however, this is only an example and the oscillation frequency is not limited to this).

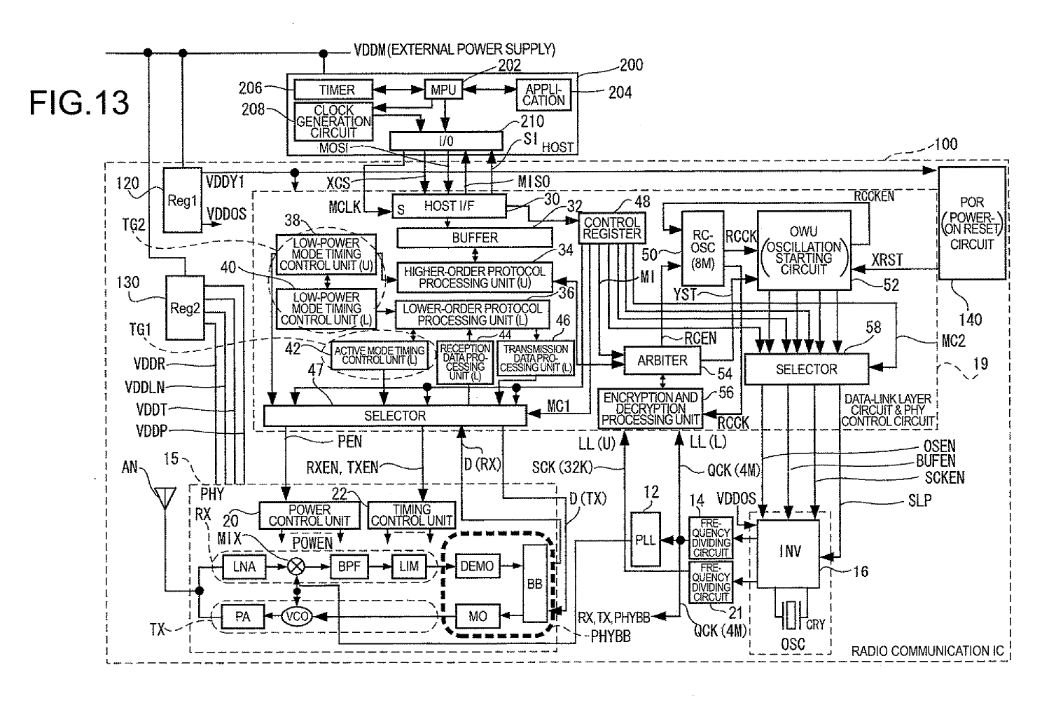

Specifically, when the IC 100 is in the second operation mode (the low-power mode), only the slow clock of 32 kHz can be used as an operation clock for the circuits. However, if the fast auxiliary clock (e.g., 8 MHz) output from the second oscillation circuit (RC-OSC) 50 can be used as the operation clock for the circuits, even in the second operation mode (the low-power mode), quick operation of the circuits is possible. The ability of signal processing of the circuits is improved. This point is explained in the next embodiment with reference to FIG. 13.

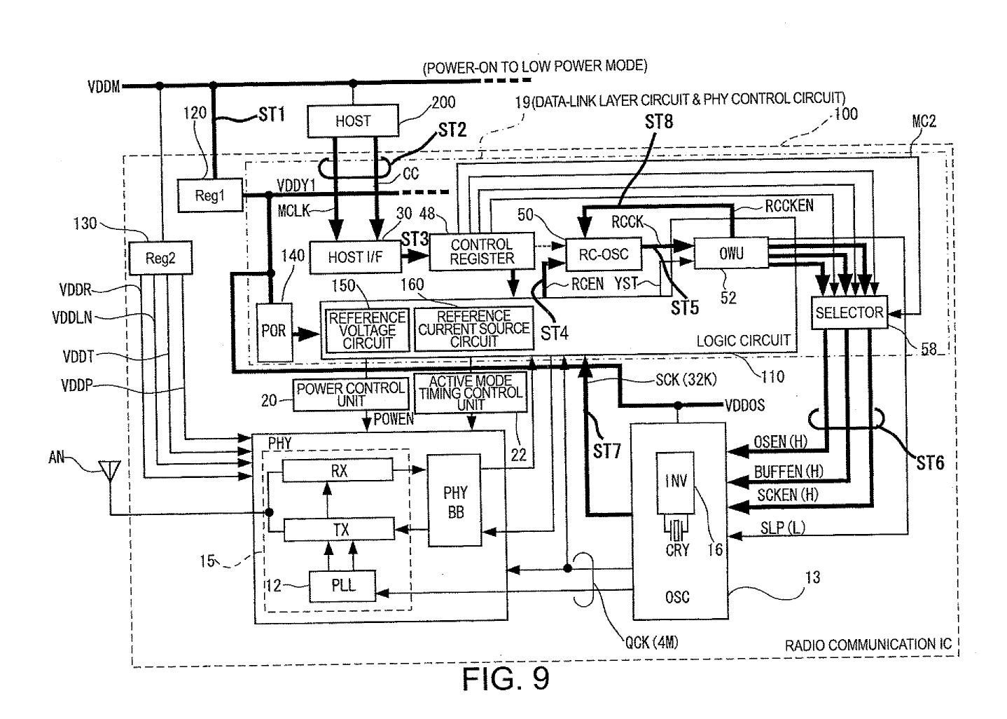

A specific operation procedure of the IC 100 in this embodiment is explained with reference to FIGS. 9 to 12. FIG. 9 is a diagram showing an operation procedure for shifting the IC to the low-power mode (the second operation mode).

When the external power supply VDDM is turned on (step ST1), the first regulator (Reg1) 120 outputs the power supply voltages VDDY1 and VDDOS. Accordingly, the IC 100 shifts to a state in which the IC 100 can receive a command from the host 200. When the host 200 outputs the command CC and the serial clock (the synchronization clock) MCLK (step ST2), the command CC and the serial clock (the synchronization clock) MCLK are received by the host interface (host I/F) 30 and the control register 48 operates (step ST3). A control signal RCEN (an enable signal for the RC oscillation circuit 50) is supplied to the second oscillation circuit (RC-OSC) 50 through the control register 48 and the logic circuit unit 110 (step ST4). The control signal RCEN output from the control register 48 may be directly supplied to the second oscillation circuit (RC-OSC) 50 without being supplied through the logic circuit unit 110 (in FIG. 9, a route of the control signal in that case is indicated by a dotted line).

The second oscillation circuit (RC-OSC) 50 starts oscillation and an auxiliary clock (e.g., 8 MHz) RCCK is supplied to the oscillation starting circuit (OWU) 52 (step ST5). The control signals ZEN (the oscillation enable signal OSEN, the buffer enable signal BUFFEN, and the slow clock enable signal SCKEN) output from the oscillation starting circuit (OWU) 52 change to an active level (e.g., an H level). These control signals are supplied to the first oscillation circuit (OSC) 13 through the selector 58 (step ST6).

The first oscillation circuit (OSC) 13 starts oscillation and the slow clock SCK (e.g., 32 KHz) is supplied to the logic circuit unit 110 (step ST7). An auxiliary clock enable signal RCCKEN supplied from the oscillation starting circuit (OWU) 52 to the second oscillation circuit (RC-OSC) 50 shifts to the disable state and the oscillation of the second oscillation circuit (RC-OSC) 50 is stopped (step ST8). Accordingly, the IC 100 shifts to the low-power mode state (the second operation mode state).

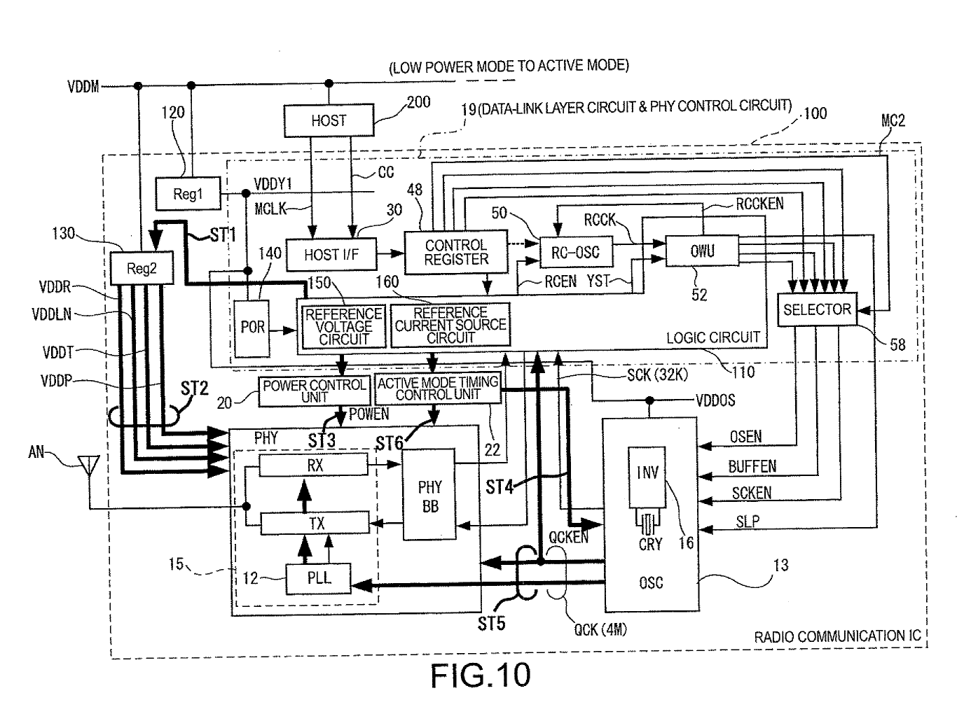

FIG. 10 is a diagram showing an operation procedure for shifting the IC from the low-power mode (the second operation mode) to the active mode (the first operation mode). The logic circuit 110 supplies a control signal to the second regulator (.Reg2) 130 and the second regulator (Reg2) 130 starts operation (step ST1). Accordingly, the second regulator (Reg2) 130 outputs the power supply voltages (VDDR, VDDLN, VDDT, and VDDP). The power supply voltages are supplied to the second regulator (Reg2) 130 (step ST2). Accordingly, the second regulator (Reg2) 130 shifts to the operation state.

Subsequently, the power control unit 20 outputs power enable POWEN on the basis of a power control signal output from the logic circuit unit 110 (step ST3). The active-mode-timing control unit 22 outputs quick clock enable QCKEN on the basis of a control signal output from the logic circuit unit 110 (step ST4). The first oscillation circuit (OSC) 13 shifts to a state in which both the slow clock SCK and the quick clock QCK are output (step ST5). The active-mode-timing control unit 22 outputs various timing signals to the physical layer circuit (PHY) 15 and operation timings for the circuits of the physical layer circuit (PHY) 15 are controlled (step ST6).

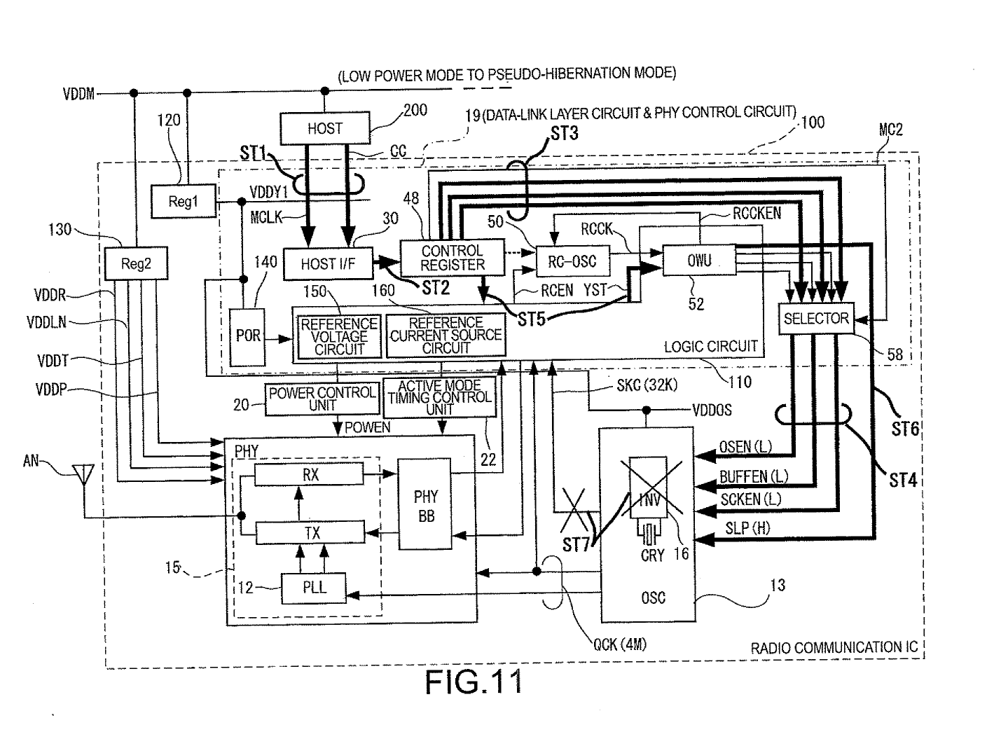

FIG. 11 is a diagram showing an operation procedure for shifting the IC from the low-power mode (the second operation mode) to the pseudo-hibernation mode (the third operation mode).

The host 200 outputs the command CC (the first command as the internal specification command) together with the serial clock MCLK (step ST1). The command CC and the serial clock MCLK are received by the host interface (host I/F) 30 and the control register 48 operates (step ST2).

The control signals ZEN (the oscillation enable signal OSEN, the buffer enable signal BUFFEN, and the slow clock enable signal SCKEN) output from the control register 48 changes to an inactive level (e.g., an L level) (step ST3). These control signals are supplied to the first oscillation circuit (OSC) 13 through the selector 58 (step ST4).

The oscillation starting circuit (OWU) 52 is reset according to a control signal YST output from the control register 48 and returns to the initial state (step ST5). Accordingly, the sleep control signal SLP supplied from the oscillation starting circuit (OWU) 52 to the first oscillation circuit (OSC) 13 changes to the active level (e.g., the H level) (step ST6). Accordingly, the oscillation of the first oscillation circuit (OSC) 13 is stopped, the first oscillation circuit (OSC) 13 shifts to a state in which the first oscillation circuit (OSC) 13 does not output the slow clock SCK, and the logic circuit unit 110 shifts to the non-operation state (step ST7). In this way, the IC 100 quickly shifts to the pseudo-hibernation mode (the third operation mode).

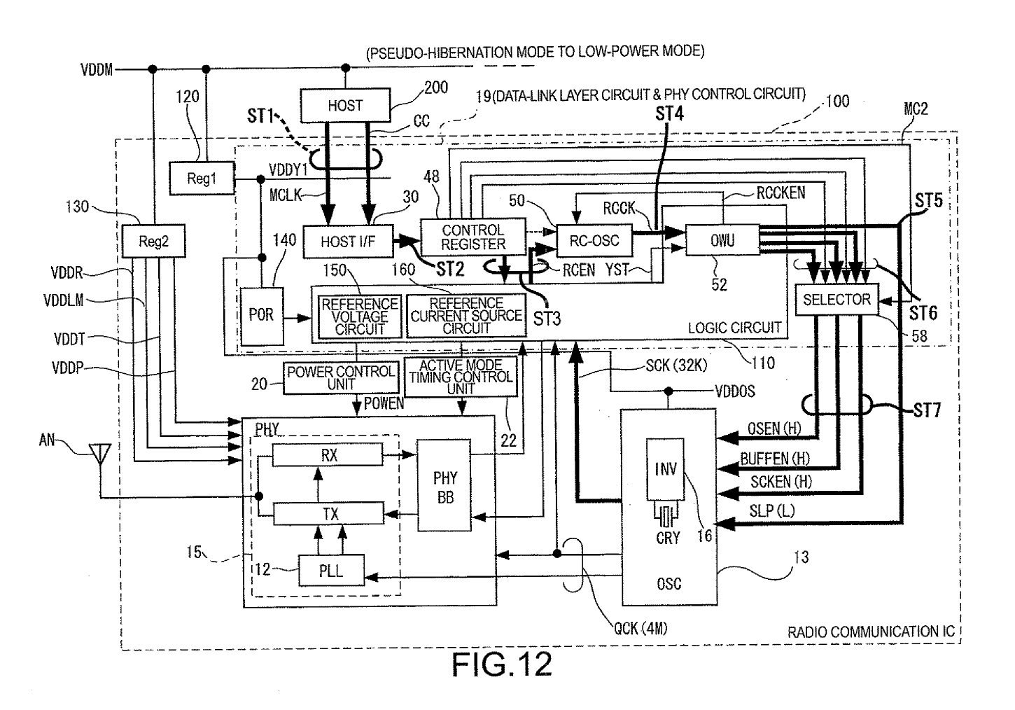

FIG. 12 is a diagram showing an operation procedure for shifting the IC from the pseudo-hibernation mode (the third operation mode) to the low-power mode (the second operation mode).

When the host 200 outputs the command CC (the second command as the internal specification command) together with the serial clock MCLK (step STI), the command CC and the serial clock MCLK are received by the host interface (host I/F) 30 and the control register 48 operates (step ST2). The control register 48 outputs the control signal RCEN (step ST3). The RC oscillation circuit (RC-OSC) 50 as the second oscillation circuit is started. An auxiliary clock output from the RC oscillation circuit (RC-OSC) 50 is supplied to the oscillation staring circuit (OWU) 52 (step ST4).

According to the start of the oscillation starting circuit (OWU) 52, the sleep control signal SLP changes to the inactive level (e.g., the L level) (step ST5). According to the sequence control by the oscillation starting circuit (OWU) 52, the oscillation enable signal OSEN, the buffer enable signal BUFFEN, and the slow clock enable signal SCKEN change to the inactive level (e.g., the L level) (step ST6). These control signals are supplied to the first oscillation circuit (OSC) 13 through the selector 58 (step ST7). Accordingly, the first oscillation circuit (OSC) 13 returns to the oscillation state and supplies the slow clock SCK to the logic circuit 110 (step ST7). Accordingly, the logic circuit unit 110 returns to the operation state. In this way, the IC 100 can quickly wake up from the third operation mode (the pseudo-hibernation state).

### Third Embodiment

In a third embodiment, other examples of the internal configuration and the operations of the radio communication IC 100 are specifically explained with reference to FIGS. 13 to 16. FIG. 13 is a diagram showing another example of the specific internal configuration of the radio communication IC. In FIG. 13, components same as those shown in the figures referred to above are denoted by the same reference numerals and signs. Redundant explanation of the components explained above is omitted.

The host 200 includes a MPU 202, a memory 204 having application software stored therein, the timer 206 for time measurement, a clock generating circuit 208, and an I/O interface 210.

The data-link layer circuit and PHY control circuit 19 includes the host interface (host I/F) 30, a buffer 32, a higher-order-protocol processing unit (U) 34 (including a command processing unit), a lower-order-protocol processing unit (L) 36, a low-power-mode-timing control unit (U) 38, a low-power-mode-timing control unit (L) 40, an active-mode-timing control unit (L) 42, a reception-data processing unit (L) 44, a transmission-data processing unit (L) 46, a selector 47, the control register 48, the RC oscillation circuit (RC-OSC) 50, the oscillation starting circuit (OWU) 52, an arbiter (an arbitration circuit) 54, an encryption and decryption processing unit 56, and the selector 58. The reception-data processing unit (L) 44 receives reception data D (RX) transmitted from the physical layer circuit (PHY) 15 and transfers the reception data D (RX) to the lower-order-protocol processing unit (L) 36. The transmission-data processing unit (L) 46 supplies transmission data D (TX), which is supplied from the lower-order protocol processing unit (L) 36, to the physical layer circuit (PHY) 15.

Circuits marked (U) indicate circuits that operate using the slow clock SCK (32 KHz) as an operation clock in the low-power mode. Circuits marked (L) indicate circuits that operate using the quick clock QCK (4 MHz) as an operation clock in the low-power mode.

The encryption and decryption processing unit 56 can operate using the auxiliary clock RCCK, which is output from the RC oscillation circuit (RC-OSC) 50 as the second oscillation circuit, as an operation clock. The arbiter 54 manages an operation procedure in performing encryption and decryption processing. The encryption and decryption processing unit 56 is started by, for example, the control register 48. For example, when the control register 48 outputs a control signal MI for starting the encryption and decryption processing unit 56, the arbiter 54 changes the control signal RCEN as the enable signal for the RC oscillation circuit (RC-OSC) 50 to the active level and oscillation of the RC oscillation circuit (RC-OSC) 50 is started. The encryption and decryption processing unit 56 operates using the auxiliary clock RCCK, which is output from the RC oscillation circuit (RC-OSC) 50, as an operation clock.

The active-mode-timing control unit (L) 42 functions as a first timing control unit TG1. The first timing control unit TG1 (the active-mode-timing control unit (L) 42) supplies a timing control signal (e.g., a control signal RXEN as an enable signal for the reception circuit RX or a control signal TXEN as an enable signal for the transmission circuit TX) to the timing control unit 22 included in the physical layer circuit (PHY) 15.

The low-power-mode-timing control unit (U) 38 and the low-power-mode-timing control unit (L) 40 functions as a second timing control unit TG2. The second timing control unit TG2 controls operation timings for the higher-order-protocol processing unit (U) 34 and the lower-order-protocol processing unit (L) 36 and supplies a timing control signal to the timing control unit 22 included in the physical layer circuit (PHY) 15.

The selector 47 is provided to enable the control register 48 to individually control the circuits included in the physical layer circuit (PHY) 15 in the debug mode (a fourth operation mode: see FIG. 2A). Switching of a signal route in the selector 47 is performed according to a switching control signal MC1 output from the control register 48.

When the normal sequence operation mode (the first operation mode and the second operation mode: see FIG. 2A) is selected, the first timing control unit TG1 and the second timing control unit TG2 provided in the data-link layer circuit and PHY control circuit 19 control operation timings for the units. When the first operation mode (the active mode) is selected, the first timing control unit TG1 controls operation timing for the physical layer circuit (PHY) 15. The second timing control unit TG2 controls operation timing for at least a part of the data-link layer circuit and PHY control circuit (PHY) 19 at the time when the second operation mode (the low-power mode) is selected (i.e., the circuit units 34 and 36 and the like in the operation state in the low-power mode) and controls the operation of the physical layer circuit (PHY) 15 to thereby control shift from the first operation mode (the active mode) to the second operation mode (the low-power mode) and shift from the second operation mode (the low-power mode) to the first operation mode (the active mode).

As explained above, when the normal sequence operation mode (the first operation mode and the second operation mode) is selected, the sequence control (the sequential timing control) by the first timing control unit TG1 and the second timing control unit TG2 based on the standard specification command is executed and transmission processing and reception processing for a radio communication signal are executed. On the other hand, when the register control mode (the third operation mode and the fourth operation mode) is selected, for example, the host 200 issues the internal specification command to set the operation mode switching bit in the control register 48 and then issues the internal specification command for designating an operation mode. When the issued internal specification command is the first command (a pseudo-hibernation instruction command), the radio communication IC 100 shifts to the third operation mode (the pseudo-hibernation mode). When the issued internal specification command is, for example, a command for instructing the debug mode, the radio communication IC 100 shifts to the debug mode. In this way, the command issued by the host 200 is supplied to the integrated circuit device through hardware same as the command scheme of the standardized circuit system communication system (the standardized system). Although the command issued by the host 200 is distinguished as the standard specification command or the internal specification command, a special command or a special control signal is not used at all. Control of the integrated circuit device from the outside is simplified. Therefore, the burden on the host 200 is sufficiently suppressed. A reduction in the burden on the host 200 also contributes to suppression of a circuit area of the host 200 and a reduction in power consumption of the host 200.

In FIG. 13, the RC oscillation circuit (RC-OSC) 50 as the second oscillation circuit is used as a supply source of the auxiliary clock RCCK to the oscillation starting circuit (OWU) 52. The RC oscillation circuit (RC-OSC) 50 is also used as a supply source of an operation clock to the other circuits (e.g., the encryption and decryption processing unit 56) included in the radio communication IC 100. Consequently, effective use of the second oscillation circuit is realized.

As explained above, the oscillation frequency of the second oscillation circuit (RC-OSC) 50 is set to a high frequency such as 8 HMz. The oscillation frequency is set taking into account that the second oscillation circuit (RC-OSC) 50 is also used as an operation clock supply source for the other circuits (however, this is only an example and the oscillation frequency is not limited to this).

In other words, when the IC 100 is in the second operation mode (the low-power mode), only a slow clock of 32 kHz can be used as an operation clock for the circuits. However, if the quick auxiliary clock (e.g., 8 MHz) RCCK output from the second oscillation circuit (RC-OSC) 50 can be used as, for example, an operation clock for the encryption and decryption processing unit 56, even in the second operation mode (the low-power mode), quick operation of the encryption and decryption processing unit 56 is possible. The ability of the encryption and decryption processing is improved. In the radio communication, it is important to secure communication security. If the RC oscillation circuit (RC-OSC) 50 as the second oscillation circuit can also be used as an operation clock source for the other circuits (e.g., the encryption and decryption processing unit 56), the effect of a reduction in an area occupied by the circuits and a reduction in power consumption is further facilitated.

It is sufficient to secure a certain degree of accuracy of an operation clock for the encryption and decryption processing (for example, accurate timing control as in the normal communication sequence is unnecessary). Therefore, for example, it is desirable to design the RC oscillation circuit (RC-OSC) 50 as the second oscillation circuit attaching more importance to an increase in speed of oscillation than accuracy. In other words, if a frequency of a clock output from the second oscillation circuit is set to a sufficiently high frequency value (e.g., a frequency value sufficiently higher than the slow clock SCK used in the second operation mode (the low-power mode)), there is an advantage that, even when encryption and decryption of data are necessary in the second operation mode (the low-power mode), the encryption and decryption of the data can be performed by using a sufficiently quick operation clock.

The reception circuit RX included in the physical layer circuit (PHY) 15 shown in FIG. 13 includes a low-noise amplifier DNA, a mixer MIX, a band-pass filter circuit BPF, and an amplifier with limiter LIM. The transmission circuit TX includes a voltage controlled oscillator VCO and a power amplifier PA. The physical layer baseband circuit (PHYBB) includes a demodulating circuit (e.g., a demodulating circuit for an FSK signal) DEMO, a modulating circuit MO, and a baseband-signal processing unit (BB). The power control unit 20 controls on and off of power supply voltages for the reception circuit RX and the transmission circuit TX. The timing control unit 22 controls operation timings for the transmission circuit TX and the circuits of the transmission circuit TX.

The first oscillation circuit (OSC) 13 (e.g., a quartz oscillator) outputs, for example, a source clock of 16 MHz. A frequency dividing circuit 14 frequency-divides the source clock of 16 MHz to generate the quick clock QCK (4 MHz). A frequency dividing circuit 21 frequency-divides the source clock of 16 MHz to generate the slow clock SCK (32 KHz). The PLL 12 generates a local signal on the basis of the quick clock QCK (4 MHz).

The first regulator (Reg1) 120 as the power supply system circuit outputs the power supply voltages VDDY1 and VDDOS. The power supply voltage VDDY1 is a power supply voltage for the data-link layer circuit and PHY control circuit 19 (including the host I/F 30, the control register 48, the RC-OSC 50, and the OWU 52). The power supply voltage VDDOS is a power supply voltage for the first oscillation circuit (OSC) 13. The second regulator (Reg2) 130 outputs the power supply voltage VDDR for the reception circuit RX, the lower supply voltage VDDLN for the low-noise amplifier LNA included in the reception circuit RX, the power supply voltage VDDT for the transmission circuit TX, and the power supply voltage VDDP for the power amplifier PA included in the transmission circuit TX.

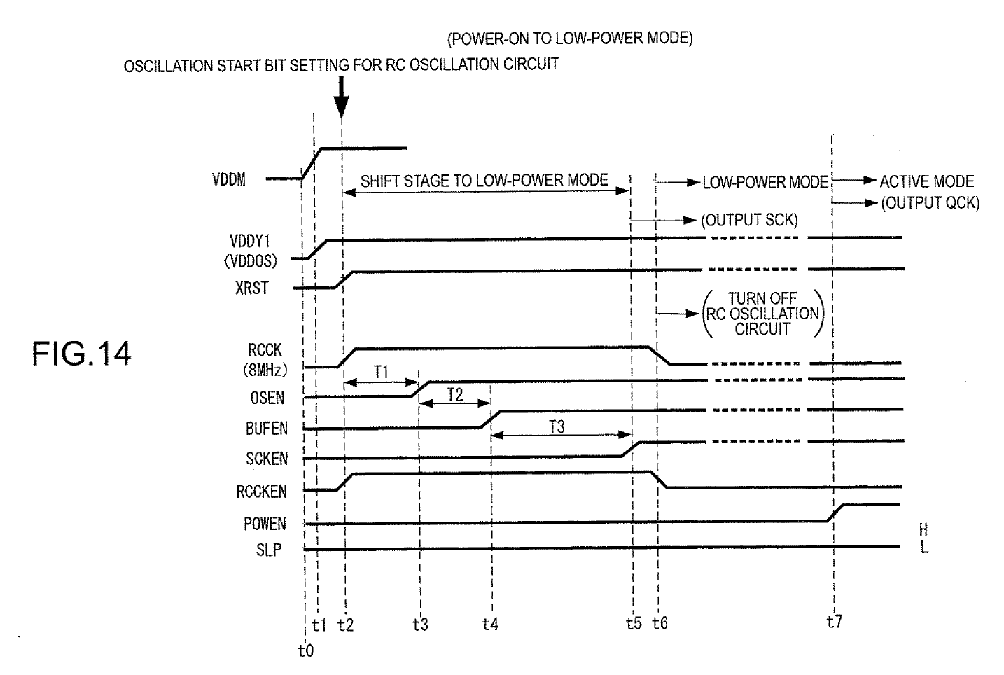

FIG. 14 is a timing chart showing an example of operation timings of power-on to the active mode of the radio communication IC shown in FIG. 13.

At time t0, the power switch (650 in FIG. 1) of the electronic apparatus (the short-distance radio terminal, etc is turned on and the external power supply VDDM shifts to an ON state. Accordingly, the power supply voltage VDDY1 rises at time t1. At time t2, a power-on reset signal XRST is changed from L to H by the power-on reset circuit (POR) 140 and reset of the circuits is released. Accordingly, the radio communication IC 100 changes to a state in which the radio communication IC 100 can receive the internal specification command from the host 200. Specifically, at time t2, on the basis of the internal specification command, the auxiliary clock enable signal RCCKEN changes from L to H, an oscillation operation of the RC oscillation circuit (RC-OSC) 50 as the second oscillation circuit is started, and the RC oscillation circuit (RC-OSC) 50 outputs the auxiliary clock RCCK.

Accordingly, the oscillation starting circuit (OWU) 52 operates and starts the sequence control of the oscillation starting circuit (OWU) 52. At time t3 when a time T1 elapses from time t2, the oscillation enable signal OSEN shifts to an active state (an output state). At time t4 when a time T2 elapses from time t3, the buffer enable signal BUFFEN shifts to the active state (the output state). At time t5 when a time T3 elapses from time t4, the slow clock enable signal SCKEN shifts to the active state (the output state). At time t5, the first oscillation circuit (OSC) 13 starts output of the slow clock SCK. At time t6, the auxiliary clock enable signal RCCKEN changes from H to L and the oscillation of the RC oscillation circuit (RC-OSC) 50 as the second oscillation circuit is stopped. At time t6, the radio communication IC 100 shifts to the low-power mode (the second operation mode).

At time t7, the low-power-mode-timing control unit (U) 38 outputs a timing control signal PEN for a power system. The power enable signal POWEN output from the power control unit 20 changes from L to H. At time t7 and subsequent time, the first oscillation circuit (OSC) 13 can use the quick clock (QCK). Accordingly, the radio communication IC 100 shifts to the active mode.

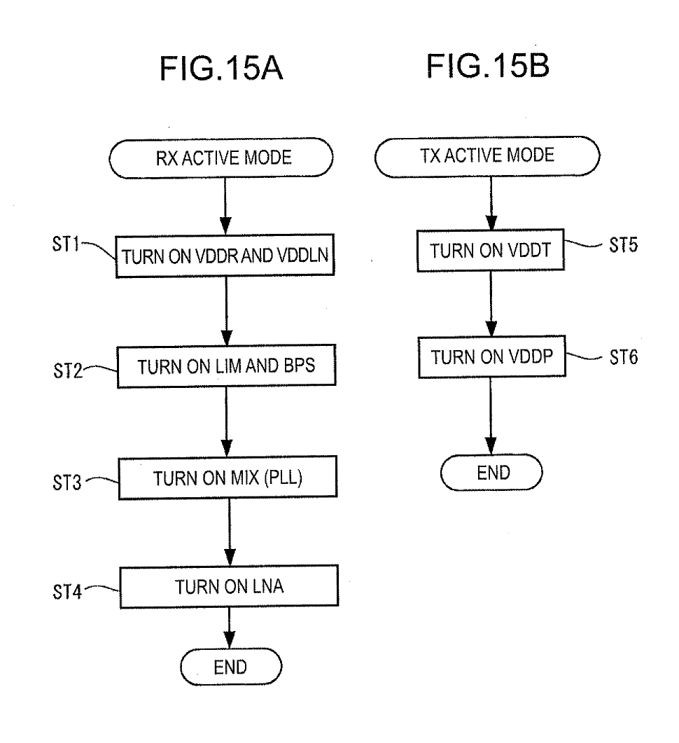

FIGS. 15A and 15B are diagrams showing examples of a power supply procedure in the reception circuit and the transmission circuit in the active mode and an operation procedure of the circuits.

Since the first operation mode (the active mode) is an operation mode with largest power consumption, in the shift from the second operation mode (the low-power mode) to the first operation mode (the active mode), as a part of a reduction in power consumption, most rational power supply management and operation procedure management (with smallest power consumption) may be executed.

Therefore, as shown in FIG. 15A, first, the power supply voltage VDDR for the reception circuit RX and the power supply voltage VDDLN for the low-noise amplifier LNA are switched from off to on (in step ST1). Subsequently, the band-pass filter circuit BPS and the amplifier with limiter LIM are shifted to the operation state (step ST2). In other words, the circuits arranged at the post stage of the mixer MIX is shifted to the operation state. Since these circuits are circuits that process a signal after a frequency is down-converted, power consumption of the circuits is considered to be small compared with that of a communication front-end unit (an RF circuit: LNA and MIX). Therefore, first, a circuit section at the post stage of the mixer MIX including the band-pass filter circuit BPS is shifted to the operation state.

Subsequently, the mixer MIX is shifted to the operation state (step ST3). When a complex mixer (an orthogonal mixer) is used, plural mixers are shifted to the operation state. Accordingly, for example, a local oscillator (the first oscillation circuit can be used as the local oscillator) that outputs a local signal and the PLL circuit 12 also start operation. Since a mixer section (including a section related to the mixer MIX) has large power consumption, return to the operation state of the mixer section is delayed. An increase in power consumption of the entire IC 100 is suppressed by delaying return to the operation state of the mixer section.

Subsequently, the low-noise amplifier LNA is shifted to the operation state (step ST4). Since the low-noise amplifier LNA is a power amplifying circuit (a power amplifier) at the initial stage and has the large power consumption, the low-noise amplifier LNA is returned to the operation state last. An increase in power consumption of the entire IC 100 is suppressed by returning the low-noise amplifier LNA to the operation state last.

Concerning the transmission circuit TX, first, the power supply voltage VDDT for the transmission circuit TX is turned on (step ST5). Subsequently, the power supply voltage VDDP of the power amplifier PA at an output stage is turned on (step ST6). Since the power amplifier PA at the output stage has large power consumption, the power amplifier PA is returned to the operation state last. An increase in power consumption of the entire IC 100 is suppressed by returning the power amplifier PA to the operation state last.

In this way, in the shift from the second operation mode (the low-power mode) to the first operation mode (the active mode), as a part of a reduction in power consumption, most rational power supply management and operation procedure management (with smallest power consumption) are realized.

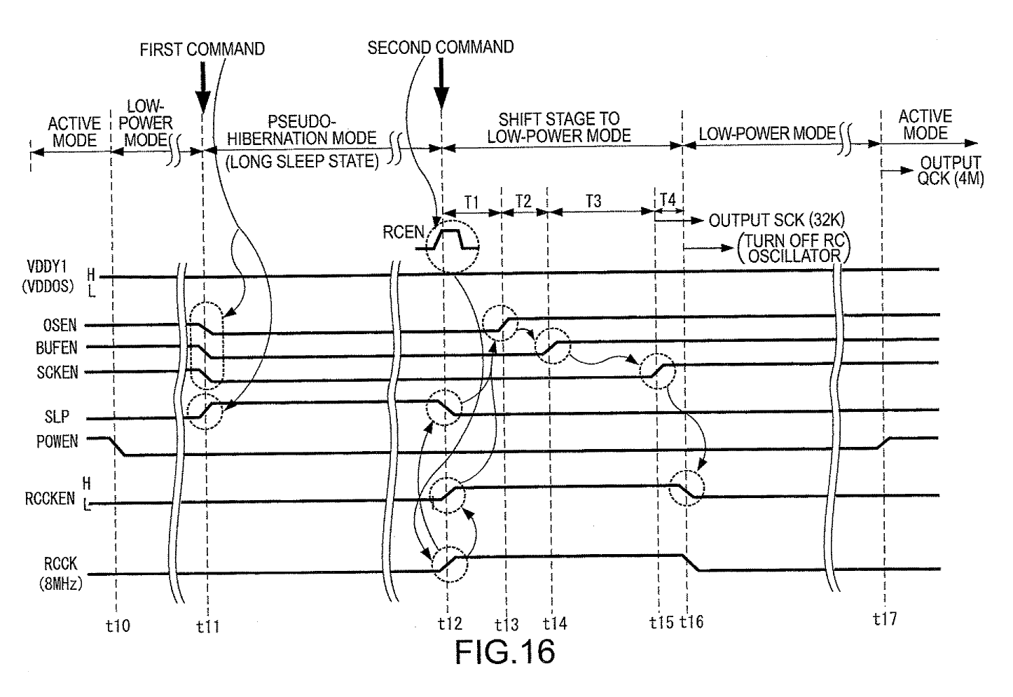

FIG. 16 is a timing chart showing an example of operation timings of the active mode to the low-power mode and the pseudo-hibernation mode and operation timings of the pseudo-hibernation mode to the active mode through the low-power mode.

At time t10, the power enable signal POWEN output from the power control unit 20 changes from H to L. Accordingly, power supply voltage for the physical layer circuit (PHY) 15 is turned off and the radio communication IC 100 shifts to the low-power mode. At time t11, when the host 200 issues the first command (the pseudo-hibernation instruction command) as the internal specification command, all of the oscillation enable signal OSEN, the buffer enable signal BUFFEN, and the slow clock enable signal SCKEN change to the inactive level (L) and the sleep control signal SLP changes to the active level (H).

At time t12, when the host 200 issues the second command (the wakeup instruction command from pseudo hibernation) as the internal specification command, the enable signal RCEN of the RC oscillation circuit (RC-OSC) 50 changes to the active level. Accordingly, oscillation of the RC oscillation circuit (RC-OSC) 50 is started and output of the auxiliary clock RCCK is started.

When the oscillation starting circuit (OWU) 52 operates, the sleep control signal SLP changes to the inactive level (L) and the auxiliary clock enable signal RCCKEN changes to the active level (H). Accordingly, the sequence control by the oscillation starting circuit (OWU) 52 is started. At time t13 when a time T1 elapses from time t12, the oscillation enable signal OSEN changes to the active state (the output state).

At time t14 when a time T2 elapses from time t13, the buffer enable signal BUFFEN changes to the active state (the output state). At time t15 when a time T3 elapses from time t14, the slow clock enable signal SCKEN changes to the active state (the output state). At time t15, the first oscillation circuit (OSC) 13 starts output of the slow clock SCK. At time t16, the auxiliary clock enable signal RCCKEN changes from H to L and the oscillation of the RC oscillation circuit (RC-OSC) 50 as the second oscillation circuit is stopped. At time t16, the radio communication IC 100 shifts to the low-power mode (the second operation mode). At time t17, the power enable signal POWEN changes from L to H. Accordingly, power supply voltage for the physical layer circuit (PHY) 15 is turned on and the radio communication IC 100 returns to the active mode.

As explained above, according to at least one embodiment of the invention, it is possible to eliminate the contradiction (divergence) that occurs between the provision contents of the standard specifications and the environment in which the electronic apparatus is actually used (actual use conditions) and realize a further reduction in power consumption of the electronic apparatus and the integrated circuit device included in the electronic apparatus.

For example, the unprecedented long sleep can be performed by shifting the IC (the integrated circuit device) to the pseudo-hibernation state. The configuration of the IC (the integrated circuit device) is simplified and the burden on the host is reduced. Therefore, miniaturization, ultra-low power consumption, and low cost of the electronic apparatus is realized. For example, it is possible to realize a small, light, ultra-low-power consumption, and low-cost radio communication device driven by a battery. The radio communication device is, for example, a short-range radio communication terminal (a short-distance radio communication terminal) conforming to the standard specifications (e.g., low-power consumption specifications).

In this way, according to at least one embodiment of the invention, it is possible to eliminate contradiction (divergence) that occurs between the standard specifications and the environment in which the electronic apparatus is actually used (actual use conditions) and realize a further reduction in power consumption of the electronic apparatus and the integrated circuit device included in the electronic apparatus.

The several embodiments have been explained. However, those skilled in the art can easily understand that various modifications are possible without substantially departing from the new matters and the effects of the invention. Therefore, all such modifications are regarded as included in the scope of the invention. For example, a term described together with a different term in a broader sense or a synonymous different term at least once in the specification or the drawings can be replaced with the different term in any place in the specification or the drawings.

What is claimed is:

1. An integrated circuit device comprising:
a host interface that receives a standard specification command issued by a host and an internal specification command, which is a command asynchronous with the standard specification command;
a register unit that is accessed through the host interface;
a logic circuit unit including a command processing unit; and
a first oscillation circuit that generates an operation clock for the logic circuit unit, wherein
the first oscillation circuit is controlled on the basis of a first command as the internal specification command issued by the host and shifts to a state in which power supply voltage is supplied but oscillation is stopped, whereby the logic circuit unit shifts to a state in which the power supply voltage is supplied but a circuit operation is stopped, and
the first oscillation circuit is controlled through the register unit on the basis of a second command as the internal specification command issued by the host and returns to an oscillation state from the state in which the oscillation is stopped, whereby the logic circuit unit returns to a state in which circuits operate from the state in which the circuit operation is stopped.

2. The integrated circuit device according to claim 1, further comprising:
a second oscillation circuit used when the first oscillation circuit is started; and
an oscillation starting circuit that operates according to an auxiliary clock output from the second oscillation circuit and executes sequence control for starting the first oscillation circuit, wherein
the second oscillation circuit is controlled by the register unit on the basis of the second command as the internal specification command issued by the host and starts the output of the auxiliary clock,
the oscillation starting circuit shifts to an operation state according to the auxiliary clock output from the second oscillation circuit and executes the sequence control, whereby the first oscillation circuit returns to the oscillation state, and
after the first oscillation circuit returns to the oscillation state, the second oscillation circuit returns to an oscillation stop state.

3. The integrated circuit device according to claim 1, wherein the host interface is a serial interface of a clock synchronization type that transfers data in synchronization with a serial clock supplied from the host,
the register unit includes a control register that can set a control bit for controlling operation of the integrated circuit device,
the register unit starts the operation on the basis of the serial clock obtained through the host interface, and
the control bit of the control register is set on the basis of the second command and a control signal for returning the first oscillation circuit to the oscillation state is output from the control register.

4. The integrated circuit device according to claim 3, wherein the control register is also used when a debug mode as an operation mode for verifying operation of the integrated circuit device is selected.

5. The integrated circuit device according to claim 1, wherein the second command is issued when a predetermined time elapses after the host issues the first command and the elapse of the predetermined time is measured by the host.

6. The integrated circuit device according to claim 1, further comprising an analog circuit unit, wherein
the integrated circuit device has
a first operation mode in which both the analog circuit unit and a logic circuit unit are in the operation state and the first oscillation circuit is in the operation state,
a second operation mode in which the analog circuit unit is in the non-operation state according to turn-off of the power supply voltage for the analog circuit unit, at least a part of the logic circuit unit is in the operation state, and the first oscillation circuit is in the operation state, and
a third operation mode in which the analog circuit unit is in the non-operation state according to turn-off of the power supply voltage for the analog circuit unit and a circuit operation of the logic circuit unit is stopped according to the stop of the oscillation of the first oscillation circuit.

7. The integrated circuit device according to claim 6, wherein
the analog circuit unit is a physical layer circuit for radio communication having at least one of a reception circuit that processes an input signal received by an antenna and a transmission circuit that executes processing for transmitting a signal from the antenna by radio, and
the logic circuit unit includes a data-link layer circuit that performs exchange of data between the physical layer circuit and the host and a physical-layer control circuit that controls operation of the physical layer circuit.

8. The integrated circuit device according to claim 7, wherein the logic circuit unit includes:
a first timing control unit that controls operation timing for the physical layer circuit in the first operation mode; and
a second timing control unit that controls operation timing for at least a part of the logic circuit unit in the second operation mode and controls shift from the first operation mode to the second operation mode and shift from the second operation mode to the first operation mode, and
an operation mode switching bit is prepared in the register unit, and
at least one of the first timing control unit and the second timing control unit switches, according to setting of the operation mode switching bit, a normal sequence operation mode for performing timing control for the integrated circuit device and a register control mode for controlling the operation of the integrated circuit device through the control register included in the register unit.

9. The integrated circuit device according to claim 8, wherein
the reception circuit in the analog circuit unit includes:
an amplifier circuit that amplifies an input signal based on a reception signal received by the antenna;
a mixer that down-converts, with mixing of a local signal, a frequency of the signal amplified by the amplifier circuit; and
a filter circuit that applies filtering processing to the signal after the down-convert, and
when the integrated circuit device is shifted from the second operation mode to the first operation mode, first, the second timing control unit switches the power supply voltage for the reception circuit from on to off, then, shifts the filter circuit to the operation state, shifts the mixer to the operation state, and shifts the amplifier circuit to the operation state.

10. The integrated circuit device according to claim 2, wherein the second oscillation circuit is used as a supply source of an operation clock to the circuits included in the integrated circuit device besides being used as a supply source of the auxiliary clock to the oscillation starting circuit.

11. An electronic apparatus comprising:
the integrated circuit device according to claim 1; and
a host as a host apparatus of the integrated circuit device.

12. The electronic apparatus according to claim 11, wherein the electronic apparatus is a radio communication apparatus driven by a battery.
